(19) United States
(12) Patent Application Publication
(10) Pub. No.: US 2016/0322044 A1
(43) Pub. Date: Nov. 3, 2016

(54) Networked User Command Recognition

(71) Applicant: Elwha LLC, Bellevue, WA (US)

(72) Inventors: Edward K.Y. Jung, Bellevue, WA (US); Royce A. Levien, Lexington, MA (US); Richard T. Lord, (US); Robert W. Lord, Seattle, WA (US); Mark A. Malamud, Seattle, WA (US); Clarence T. Tegreene, Mercer Island, WA (US)

(21) Appl. No.: 15/087,090

(22) Filed: Mar. 31, 2016

Related U.S. Application Data
(60) Provisional application No. 62/141,736, filed on Apr. 1, 2015.
(60) Provisional application No. 62/235,202, filed on Sep. 30, 2015.

(51) Int. Cl. G10L 15/065; H04L 29/08; G10L 17/22; G10L 15/22; G06F 3/01

(52) U.S. Cl. CPC G10L 15/065; G10L 15/22; G06F 3/017; G10L 17/22; H04L 67/12; G10L 2015/223

(57) ABSTRACT

Systems, methods, computer-readable storage mediums including computer-readable instructions and/or circuitry for generating deceptive indicia profiles may implement operations including, but not limited to: receiving one or more signals from at least one of a plurality of connected devices; determining a vocabulary for each of the plurality of connected devices to generate a system vocabulary; identifying one or more commands from the one or more signals based on the system vocabulary; and generating one or more command responses based on the one or more commands.

### CROSS-REFERENCE TO RELATED APPLICATIONS

The present application is related to and claims the benefit of the earliest available effective filing date(s) from the following listed application(s) (the “Related Applications”) (e.g., claims earliest available priority dates for other than provisional patent applications or claims benefits under 35 USC §119(e) for provisional patent applications, for any and all parent, grandparent, great-grandparent, etc. applications of the Related Application(s)). All subject matter of the Related Applications and of any and all parent, grandparent, great-grandparent, etc. applications of the Related Applications, including any priority claims, is incorporated herein by reference to the extent such subject matter is not inconsistent herewith.

### RELATED APPLICATIONS

For purposes of the USPTO extra-statutory requirements, the present application claims priority to the United States patent application filed under U.S. Patent Application Ser. No. 62/141,736 entitled NETWORKED SPEECH RECOGNITION, naming Robert W. Lord and Richard T. Lord as inventors, filed Apr. 1, 2015, which is currently co-pending or is an application of which a currently co-pending application is entitled to the benefit of the filing date.

For purposes of the USPTO extra-statutory requirements, the present application claims priority to the United States patent application filed under U.S. Patent Application Ser. No. 62/235,202 entitled DISTRIBUTED SPEECH RECOGNITION SERVICES, naming Robert W. Lord and Richard T. Lord as inventors, filed Sep. 30, 2015, which is currently co-pending or is an application of which a currently co-pending application is entitled to the benefit of the filing date.

The United States Patent Office (USPTO) has published a notice to the effect that the USPTO's computer programs require that patent applicants reference both a serial number and indicate whether an application is a continuation, continuation-in-part, or divisional of a parent application. Stephen G. Kunin, Benefit of Prior-Filed Application, USPTO Official Gazette Mar. 18, 2003. The present Applicant Entity (hereinafter “Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant has provided designation(s) of a relationship between the present application and its parent application(s) as set forth above, but expressly points out that such designation(s) are not to be construed in any way as any type of commentary and/or admission as to whether or not the present application contains any new matter in addition to the matter of its parent application(s).

### SUMMARY

Systems, methods, computer-readable storage mediums including computer-readable instructions and/or circuitry for masking deceptive indicia in communications content may implement operations including, but not limited to: receiving one or more signals from at least one of a plurality of connected devices; determining a vocabulary for each of the plurality of connected devices to generate a system vocabulary; identifying one or more commands from the one or more signals based on the system vocabulary; and generating one or more command responses based on the one or more commands.

In one or more various aspects, related systems include but are not limited to circuitry and/or programming for effecting the herein referenced aspects; the circuitry and/or programming can be virtually any combination of hardware, software, and/or firmware configured to effect the herein-referenced method aspects depending upon the design choices of the system designer.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

FIG. 1A shows a high-level block diagram of an operational environment.

FIG. 1B shows a high-level block diagram of an operational procedure.

FIG. 2 shows an operational procedure.

FIG. 3 shows an alternative embodiment of the operational procedure of FIG. 2.

FIG. 4 shows an alternative embodiment of the operational procedure of FIG. 2.

FIG. 5 shows an alternative embodiment of the operational procedure of FIG. 2.

FIG. 6 shows an alternative embodiment of the operational procedure of FIG. 2.

FIG. 7 shows an alternative embodiment of the operational procedure of FIG. 2.

FIG. 8 shows an alternative embodiment of the operational procedure of FIG. 2.

FIG. 9 shows an alternative embodiment of the operational procedure of FIG. 2.

FIG. 10 shows an alternative embodiment of the operational procedure of FIG. 2.

FIG. 11 shows an alternative embodiment of the operational procedure of FIG. 2.

FIG. 12 shows an alternative embodiment of the operational procedure of FIG. 2.

FIG. 13 shows an alternative embodiment of the operational procedure of FIG. 2.

FIG. 14 shows an alternative embodiment of the operational procedure of FIG. 2.

FIG. 15 shows an alternative embodiment of the operational procedure of FIG. 2.

FIG. 16 shows an alternative embodiment of the operational procedure of FIG. 2.

FIG. 17 shows an alternative embodiment of the operational procedure of FIG. 2.

FIG. 18 shows an alternative embodiment of the operational procedure of FIG. 2.

FIG. 19 shows an alternative embodiment of the operational procedure of FIG. 2.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

A connected network of devices (e.g. an “internet of things”) may provide an flexible platform in which a user may control or otherwise interact with any device within the network. A user may interface with one or more devices in a variety of ways including by issuing commands on an interface (e.g. a computing device). Additionally, a user may interface with one or more devices through a natural input mechanism such as through verbal commands, by gestures, and the like. However, interpretation of natural input commands and analysis of the commands in light of contextual attributes may be beyond the capabilities of some devices on the network. This may be by design (e.g. limited processing power), or by utility (e.g. to minimize power consumption of a portable device). Further, not all devices on the network may utilize the same set of commands.

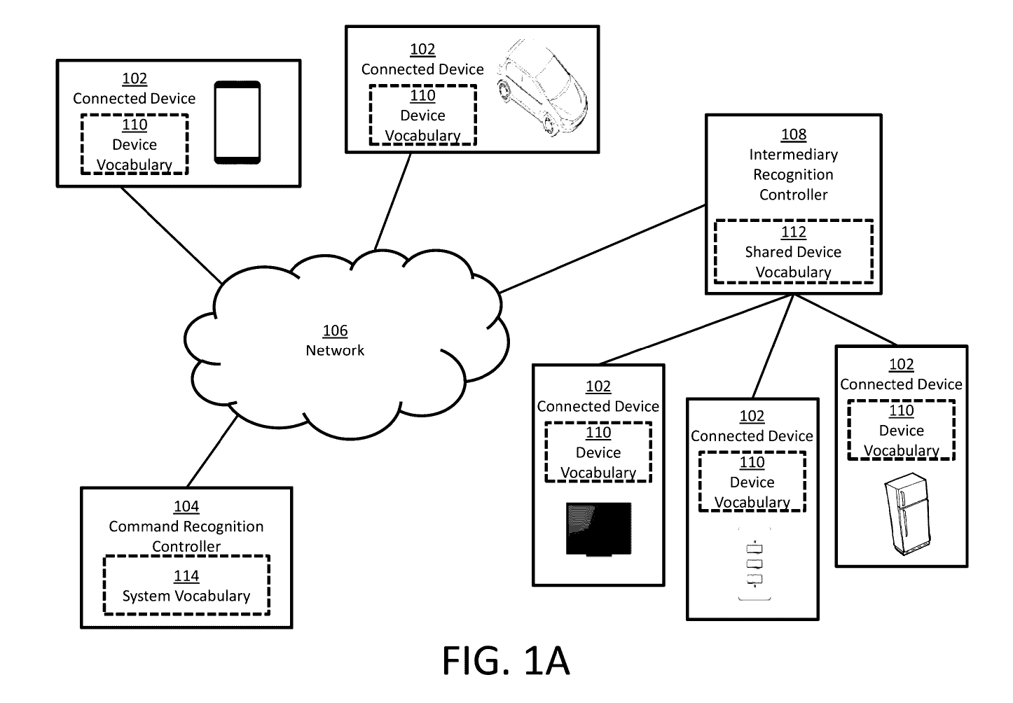

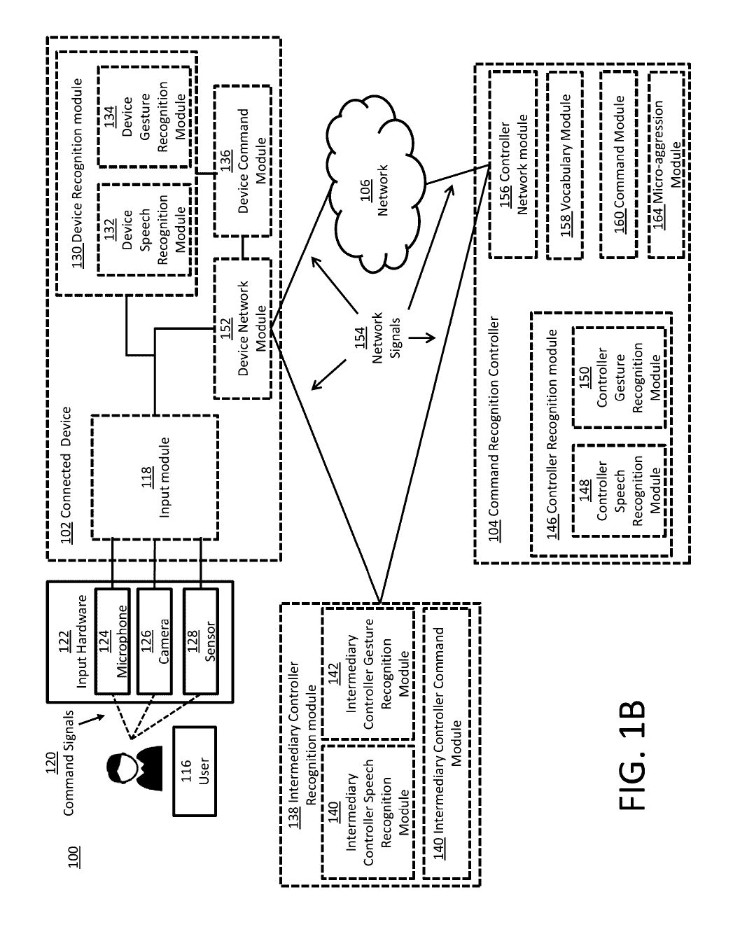

FIG. 1A illustrates a connected device network 100 including one or more connected devices 102 connected to a command recognition controller 104 by a network 106, in accordance with one or more illustrative embodiments of the present disclosure. The connected devices 102 may be configured to receive and/or record data indicative of commands (e.g. a verbal command or a gesture command). As such, the data indicative of commands may be transmitted via the network 106 to the command recognition controller 104 which may implement one or more recognition applications on one or more processing devices having sufficient processing capabilities. Upon receipt of the data, the command recognition controller 104 may perform one or more recognition operations (e.g. speech recognition operations or gesture recognition operations) on the data. The command recognition controller 104 may utilize any speech recognition (or voice recognition) technique known in the art including, but not limited to, hidden Markov models, dynamic time warping techniques, neural networks, or deep neural networks. For example, the command recognition controller 104 may utilize a hidden Markov model including context dependency for phenomes and vocal tract length normalization to generate male/female normalized recognized speech. Further, command recognition controller 104 may utilize any gesture recognition (static or dynamic) technique known in the art including, but not limited to three-dimensional-based algorithms, appearance-based algorithms, or skeletal-based algorithms. The command recognition controller 104 may additionally implement gesture recognition using any input implementation known in the art including, but not limited to, depth-aware cameras (e.g. time of flight cameras and the like), stereo cameras, or one or more single cameras.

Following such recognition operations, the command recognition controller 104 may provide one or more control instructions to at least one of the connected devices 102 so as to control one or more functions of the connected devices 102. As such, the command recognition controller 104 may operate as a “speech-as-a-service” or a “gesture-as-a-service” module for the connected device network 100. In this regard, connected devices 102 with limited processing power for recognition operations may operate with enhanced functionality within the connected device network 100. Further, connected devices 102 with advanced functionality (e.g. a “smart” appliance with voice commands) may enhance the operability of connected devices 102 with limited functionality (e.g. a “traditional” appliance) by providing connectivity between all of connected devices 102 within the connected device network 100.

Additionally, connected devices 102 within a connected device network 100 may operate as a distributed network of input devices. In this regard, any of the connected devices 102 may receive a command intended for any of the other connected devices 102 within the connected device network 100.

A command recognition controller 104 may be located locally (e.g. communicatively coupled to the connected devices 102 via a local network 106) or remotely (e.g. located on a remote host and communicatively coupled to the connected devices 102 via the internet). Further, a command recognition controller 104 may be connected to a single connected device network 100 (e.g. a connected device network 100 associated with a home or business) or more than one connected device network 100. For example, a command recognition controller 104 may be provided by a third-party server (e.g. an Amazon service running on RackSpace servers). As another example, a command recognition controller 104 may be provided by a service provider such as a home automation provider (e.g. Nest/Google, Apple, Microsoft, Amazon, Comcast, Cox, Xanadu, and the like), security companies (e.g. ADT and the like), an energy utility, a mobile company (e.g. Verizon, AT&T, and the like), automobile companies, appliance/electronics companies (e.g. Apple, Samsung, and the like).

Further, a connected device network 100 may include more than one controller (e.g. more than one command recognition controller 104 and/or more than one intermediary recognition controller 108). For example, a command received by connected devices 102 may be sent to a local controller or a remote controller either in sequence or in parallel. In this regard, “speech-as-a-service” or “gesture-as-a-service” operations may be escalated to any level (e.g. a local level or a remote level) based on need. Additionally, it may be the case that a remote-level controller may provide more functionality (e.g. more advanced speech/gesture recognition, a wider information database, and the like) than a local controller. In some exemplary embodiments, a command recognition controller 104 may communicate with an additional command recognition controller 104 or any remote host (e.g. the internet) to perform a task. Additionally, cloud-based services (e.g. Microsoft, Google or Amazon) may develop custom software for a command recognition controller 104 and then provide a unified service that may take over recognition/control functions whenever a local command recognition controller 104 indicates that it is unable to properly perform recognition operations.

The connected devices 102 within the connected device network 100 may include any type of device known in the art suitable for accepting a natural input command. For example, as shown in FIG. 1A, the connected devices 102 may include, but are not limited to, a computing device, a mobile device (e.g. a mobile phone, a tablet, a wearable device, or the like), an appliance (e.g. a television, a refrigerator, a thermostat, or the like), a light switch, a sensor, a control panel, a remote control, or a vehicle (e.g. an automobile, a train, an aircraft, a ship, or the like).

In one illustrative embodiment, each of the connected devices 102 contains a device vocabulary 110 including a database of recognized commands. For example, a device vocabulary 110 may contain commands to perform a function or provide a response (e.g. to a user). For example, a device vocabulary 110 of a television may include commands associated with functions such as, but not limited to powering the television on, powering the television off, selecting a channel, or adjusting the volume. As another example, a device vocabulary 110 of a thermostat may include commands associated with adjusting a temperature, or controlling a fan. As a further example, a device vocabulary 110 of a light switch may include commands associated with functions such as, but not limited to powering on luminaires, powering off luminaires, controlling the brightness of luminaires, or controlling the color of luminaires. As an additional example, a device vocabulary 110 of an automobile may include commands associated with adjusting a desired speed, adjusting a radio, or manipulating a locking mechanism.

It may be the case that at least two of the connected devices 102 share a common device vocabulary 110 (e.g. a shared device vocabulary 112). In one exemplary embodiment, the connected device network 100 includes an intermediary recognition controller 108 to interface with the connected devices 102 and including a shared device vocabulary 112. For example, in another exemplary embodiment, the connected devices 102 with a shared device vocabulary 112 communicate directly with the command recognition controller 104.

It is noted that connected devices 102 may include a shared device vocabulary 112 for any number of purposes. For example, connected devices 102 associated with a common vendor may utilize the same command set and thus have a shared device vocabulary 112. As another example, connected devices 102 may share a standardized communication protocol to facilitate connectivity within the connected device network 100.

In some exemplary embodiments, the command recognition controller 104 generates a system vocabulary 114 based on the device vocabulary 110 of each of the connected devices 102. Further, the system vocabulary 114 may include commands from any shared device vocabulary 112 within the connected device network 100. In this regard, the command recognition controller 104 may identify one or more commands and/or issue control instructions associated with any of the connected devices 102 within the connected device network 100.

FIG. 1B further illustrates a user 116 interacting with one of the connected devices 102 communicatively coupled to a command recognition controller 104 within a network 106 as part of a connected device network 100. In one exemplary embodiment, the connected devices 102 include an input module 118 to receive one or more command signals 120 from input hardware 122 operably coupled to the connected devices 102.

The input hardware 122 may be any type of hardware suitable for capturing command signals 120 from a user 116 including, but not limited to a microphone 124, a camera 126, or a sensor 128. For example, the input hardware 122 may include a microphone 124 to receive speech generated by the user 116. In one exemplary embodiment, the input hardware 122 includes an omni-directional microphone 124 to capture audio signals throughout a surrounding space. In another exemplary embodiment, the input hardware 122 includes a microphone 124 with a directional polar pattern (e.g. cardioid, super-cardioid, figure-8, or the like). For example, the connected devices 102 may include a connected television configured to with a microphone 124 with a cardioid polar pattern such that the television is most sensitive to speech directed directly at the television. Accordingly, the directionality of the microphone 124, alone or in combination with other input hardware 122, may serve to facilitate determination of whether or not a user 116 is intending to direct a command signals 120 to the microphone 124.

As another example, the input hardware 122 may include a camera 126 to receive image data and/or video data representative of a user 116. In this regard, a camera 126 may capture command signals 120 including data indicative of an image of the user 116 and/or one or more stationary poses or moving gestures indicative of one or more commands. As a further example, the input hardware 122 may include a sensor 128 to receive data associated with the user 116. In this regard, a sensor 128 may include, but is not limited to, a motion sensor, a physiological sensor (e.g. for facial recognition, eye tracking, or the like).

As noted above, it may be the case that the connected devices 102 of a connected device network 100 may contain varying levels of processing power for analyzing and/or identifying the command signals 120. In one exemplary embodiment, some of the connected devices 102 include a device recognition module 130 coupled to the input module 118 to identify one or more commands based on the device vocabulary 110. For example, a device recognition module 130 may include a device speech recognition module 132 and/or a device gesture recognition module 134 for processing the command signals 120 to identify one or more commands based on the device vocabulary 110. More specifically, a device recognition module 130 may include circuitry to parse command signals 120 into distinct words, phrases, sentences, images, static poses, and/or dynamic gestures and may further include circuitry to analyze the parsed words, phrases, sentences, images, static poses, and/or dynamic gestures to identify one or more command words associated with a device vocabulary 110.

As further shown in FIG. 1B, the connected devices 102 may include a device command module 136 to identify one or more commands based on the device vocabulary 110. For example, a device command module 136 may receive the output of the device recognition module 130 (e.g. one or more words, phrases, sentences, static poses, dynamic gestures, and the like) to identify one or more commands based on the device vocabulary 110. In this regard, the connected devices 102 may provide recognition services (e.g. speech and/or gesture recognition).

As noted above, the connected devices 102 may lack sufficient processing power to perform recognition operations (e.g. speech recognition and/or gesture recognition). Accordingly, not all of the connected devices 102 include a device recognition module 130. The connected devices 102 may transmit all or a portion of command signals 120 captured by input hardware 122 to a controller in the connected device network 100 (e.g. an intermediary recognition controller 108 or a command recognition controller 104) for recognition operations. Accordingly, as shown in FIG. 1B, an intermediary controller recognition module 138 may include an intermediary speech recognition module 140 and/or an intermediary gesture recognition module 142 for parsing command signals 120 into distinct words, phrases, sentences, images, static poses, and/or dynamic gestures. Further, an intermediary recognition controller 108 may include an intermediary command module 144 for identifying one or more commands based on the output of the intermediary controller recognition module 138.

Similarly, as further shown in FIG. 1B, the command recognition controller 104 may include a controller recognition module 146 to analyze command signals 120 transmitted via the network 106. For example, the controller recognition module 146 may include a controller speech recognition module 148 and/or a controller gesture recognition module 150 to parse command signals 120 into distinct words, phrases, sentences, images, static poses, and/or dynamic gestures associated. Further, any recognition module (e.g. a device recognition module 130, an intermediary controller recognition module 138, or a controller recognition module 146) may include circuitry to mitigate the effects of noise in the command signals 120 (e.g. noise cancellation circuitry or noise reduction circuitry).

In another exemplary embodiment, the connected devices 102 include a device network module 152 for communication via the network 106. In this regard, a device network module 152 may include circuitry (e.g. a network adapter) for transmitting and/or receiving one or more network signals 154. For example, the network signals 154 may include a representation of the command signals 120 from the input module 118 (e.g. associated with connected devices 102 with limited processing power). As another example, the network signals 154 may include data from a device recognition module 130 including identified commands based on the device vocabulary 110.

The device network module 152 may include a network adapter to translate the network signals 154 according to a defined network protocol for the network 106 so as to enable transmission of the network signals 154 over the network 106. For example, the device network module 152 may include a wired network adapter (e.g. an Ethernet adapter), a wireless network adapter (e.g. a Wi-Fi network adapter), a cellular network adapter, and the like.

As further shown in FIG. 1B, the connected devices 102 may communicate, via the device network module 152 via network 106 to any device including, but not limited to, a command recognition controller 104, an intermediary recognition controller 108 and any additional connected devices 102 on the network 106. The network 106 may have any topology known in the art including, but not limited to a mesh topology, a ring topology, a star topology, or a bus topology. For example, the network 106 may include a wireless mesh topology. Accordingly, devices on the network 106 may include a device network module 152 including a wireless network adapter and an antenna for wireless data communication. Further, network signals 154 may propagate between devices on the network 106 (e.g. between the connected devices 102 and the command recognition controller 104) along any number of paths (e.g. single hop paths or multi-hop paths). In this regard, any device on the network 106 (e.g. the connected devices 102) may serve as repeaters to extend a range of the network 106.

The network 106 may utilize any protocol known in the art such as, but not limited to, Ethernet, Wi-Fi, Bluetooth, Bluetooth Low Energy (BLE), Zigbee, Z-Wave, powerline, or Thread. It may be the case that the network 106 includes multiple communication protocols. For example, devices on the network 106 (e.g. the connected devices 102 may communicate primarily via a primary protocol (e.g. a Wi-Fi protocol) or a backup protocol (e.g. a BLE protocol) in the case that the primary protocol is unavailable. Further, it may be the case that not all connected devices 102 communicate via the same protocol. In one exemplary embodiment, a connected device network 100 may include a set of connected devices 102 (e.g. light switches) that communicate across the network 106 via a mesh BLE protocol, a set of connected devices 102 (e.g. a thermostat and one or more connected appliances) that communicate across the network 106 via a Wi-Fi protocol, a set of connected devices 102 (e.g. media equipment) that communicate across the network 106 via a wired Ethernet protocol, a set of connected devices 102 (e.g. sensors) that communicate to an intermediary recognition controller 108 (e.g. a hub) via a proprietary wireless protocol, which further communicates across the network 106 via a wired Ethernet protocol, and a set of connected devices 102 (e.g. mobile devices) that communicate across the network 106 via a cellular network protocol. It is noted herein that a network 106 may have any configuration known in the art. Accordingly, the descriptions of the network 106 above or in FIG. 1A or 1B are provided merely for illustrative purposes and should not be interpreted as limiting.

The network signals 154 may be transmitted and/or received by a corresponding controller network module 156 (e.g. on a command recognition controller 104 as shown in FIG. 1B) similar to the device network module 152. For example, the controller network module 156 may include a network adapter (a wired network adapter, a wireless network adapter, a cellular network adapter, and the like) to translate the network signals 154 transmitted across the network 106 according to the network protocol back into the native format (e.g. an audio signal, an image signal, a video signal, one or more identified commands based on a device vocabulary 110, and the like). The data from the controller network module 156 may then be analyzed by the command recognition controller 104.

In one exemplary embodiment, the command recognition controller 104 contains a vocabulary module 158 including circuitry to generate a system vocabulary 114 based on the device vocabulary 110 of one or more connected devices 102. The system vocabulary 114 may be further based on a shared device vocabulary 112 associated with an intermediary recognition controller 108. For example, the vocabulary module 158 may include circuitry for generating a database of commands available to any device in the connected device network 100. Further, the vocabulary module 158 may associate commands from each device vocabulary 110 and/or shared device vocabulary 112 with the respective connected devices 102 such that the command recognition controller 104 may properly interpret commands and issue control instructions. Further, the vocabulary module 158 may modify the system vocabulary 114 to require additional information not required by a device vocabulary 110. For example, a connected device network 100 may include multiple connected devices 102 having “power off” as a command word associated with each device vocabulary 110. The vocabulary module 158 may update the system vocabulary 114 to include a device identifier (e.g. “power television off”) to mitigate ambiguity.

The vocabulary module 158 may update the system vocabulary 114 based on the available connected devices 102. For example, the command recognition controller 104 may periodically poll the connected device network 100 to identify any connected devices 102 and direct the vocabulary module 158 to add commands to or remove commands from the system vocabulary 114 accordingly. As another example, the command recognition controller 104 may update the system vocabulary 114 with a device vocabulary 110 of all newly discovered connected devices 102.

It is noted that generation or update of a system vocabulary 114 may be initiated by the command recognition controller 104 or any connected devices 102. For example, connected devices 102 may broadcast (e.g. via the network 106) a device vocabulary 110 to be associated with a system vocabulary 114. Additionally, a command recognition controller 104 may request and/or retrieve (e.g. via the network 106) any device vocabulary 110 or shared device vocabulary 112.

The vocabulary module 158 may further update the system vocabulary 114 based on feedback or direction by a user 116. In this regard, a user 116 may define a subset of commands associated with the system vocabulary 114 to be inactive. As an illustrative example, a connected device network 100 may include multiple connected devices 102 having “power off” as a command word associated with each device vocabulary 110. A user 116 may deactivate one or more commands within the system vocabulary 114 to mitigate ambiguity (e.g. only a single “power off” command word is activated).

The command recognition controller 104 may include a command module 160 with circuitry to identify one or more commands associated with the system vocabulary 114 based on the parsed output of the controller speech recognition module 148 (or, alternatively, the parsed output of the device recognition module 130 of the connected devices 102 transmitted to the command recognition controller 104 via the network 106). For example, the command module 160 may utilize the output of a controller speech recognition module 148 of the controller recognition module 146 to analyze and interpret speech associated with a user 116 to identify one or more commands based on the system vocabulary 114 provided by the vocabulary module 158.

Upon identification of one or more commands associated with the system vocabulary 114, the command module 160 may generate a command response based on the one or more commands. The command response may be of any type known in the art such as, but not limited to, a verbal response, a visual response, or one or more control instructions to one or more connected devices 102. Further, the command recognition controller 104 may transmit the command response via the controller network module 156 over the network 106 to one or more target connected devices 102.

For example, the command module 160 may direct one or more connected devices 102 to provide an audible response (e.g. a verbal response) to a user 116 (e.g. by one or more speakers). In this regard, command signals 120 from a user 116 may be “what temperature is the living room?” and a command response may include a verbal response “sixty eight degrees” in a simulated voice provided by one or more speakers associated with connected devices 102.

In another example, the command module 160 may direct one or more connected devices 102 to provide a visual response to a user 116 (e.g. by light emitting diodes (LEDs) or display devices associated with connected devices 102).

In an additional example, the command module 160 may provide a command response in the form of a computer-readable file. For example, the command response may be to update a list stored locally or remotely. Additionally, the command response may be to add, delete, or modify a calendar appointment.

In a further example, the command module 160 may provide control instructions to one or more target connected devices 102 based on the device vocabulary 110 associated with the target connected devices 102. For example, the command response may be to actuate one or more connected devices 102 (e.g. to actuate a device, to turn on a light, to change a channel of a television, to adjust a thermostat, to display a map on a display device, or the like). It is noted that the target connected devices 102 need not be the same connected devices 102 that receive the command signals 120. In this regard, any connected devices 102 within the connected device network 100 may operate to receive command signals 120 to be transmitted to the command recognition controller 104 to produce a command response. Further, a command recognition controller 104 may generate more than one command response upon analysis of command signals 120. For example, a command recognition controller 104 may provide control instructions to power off multiple connected devices 102 (e.g. luminaires) upon analysis of command signals 120 including “turn off the lights.”

In one exemplary embodiment, the command recognition controller 104 includes circuitry to identify a spoken language based on the command signals 120 and/or output from a controller speech recognition module 148. Further, a command recognition controller 104 may identify one or more commands based on the identified language. In this regard, one or more command signals 120 in any language understandable by the command recognition controller 104 may be mapped to one or more commands associated with the system vocabulary 114. Additionally, a command recognition controller 104 may extend the language-processing functionality of connected devices 102 in the connected device network 100. For example, a command recognition controller 104 may supplement, expand, or enhance speech recognition functionality (e.g. provided by a device recognition module 130) of connected devices 102 (e.g. FireTV, and the like).

It may be the case that a user 116 does not provide a verbatim recitation of a command associated with the system vocabulary 114 (e.g. a word, a phrase, a sentence, a static pose, or a dynamic gesture). Accordingly, the command module 160 may include circuitry to analyze (e.g. via a statistical analysis, an adaptive learning technique, and the like) components of the output of the controller recognition module 146 or the command signals 120 directly to identify one or more commands. Further, the command recognition controller 104 may adaptively learn idiosyncrasies of a user 116 in order to facilitate identification of commands by the command module 160 or to update the system vocabulary 114 by the vocabulary module 158. For example, the command recognition controller 104 may adapt to a user 116 with an accent affecting pronunciation of one or more commands. As another example, the command recognition controller 104 may adapt to a specific variation of a gesture control (e.g. an arrangement of fingers in a static pose gesture or a direction of motion of a dynamic gesture). Further, the command recognition controller 104 may adapt to more than one user 116.

The command recognition controller 104 may adapt to identify one or more commands associated with the system vocabulary 114 based on feedback (e.g. from a user 116). In this regard, a user 116 may indicate that a command response generated by the command recognition controller 104 was inaccurate. For example, a command recognition controller 104 may provide control instructions for connected devices 102 including luminaires to power off upon reception of command signals 120 including “turn off the lights.” In response, a user 116 may provide feedback (e.g. additional command signals 120) including “no, leave the hallway light on.” Further, the command module 160 of a command recognition controller 104 may adaptively learn and modify control instructions in response to feedback. As another example, the command recognition controller 104 may identify that command signals 120 received by selected connected devices 102 tend to receive less feedback (e.g. indicating a more accurate reception of the command signals 120). Accordingly, the command recognition controller 104 may prioritize command signals 120 from the selected connected devices 102.

In some exemplary embodiments, the command recognition controller 104 generates a command response based on contextual attributes. The contextual attributes may be associated with any of, but are not limited to, ambient conditions, a user 116, or the connected devices 102. Further, the contextual attributes may be determined by the command recognition controller 104 (e.g. the number and type of connected devices 102), or by a sensor 128 (e.g. a light sensor, a motion sensor, an occupancy sensor, or the like) associated with at least one of the connected devices 102. Further, the command recognition controller 104 may respond to contextual attributes through internal logic (e.g. one or more rules) or query an external source (e.g. a remote host).

For example, the command recognition controller 104 may generate a command response based on contextual attributes including the number and type of connected devices 102 in the connected device network 100. Further, a command module 160 may selectively generate control instructions to selected target connected devices 102 based on command signals 120 including ambiguous or broad commands (e.g. commands associated with more than one device vocabulary 110). In this regard, the command recognition controller 104 may interpret a broad command including “turn everything off” to be “turn off the lights” and consequently direct a command module 160 to generate control instructions selectively for connected devices 102 including light control functionality.

As another example, the command recognition controller 104 may generate a command response based on a state of one or more target connected devices 102. For example, a command response may be to toggle a state (e.g. powered on/powered off) of connected devices 102. Additionally, a command response may be based on a continuous state (e.g. the volume of an audio device or the set temperature of a thermostat). In this regard, in response to command signals 120 including “turn up the radio,” the command recognition controller 104 may generate command instructions to increase the volume of a radio operating as one of the connected devices 102 beyond a current set point.

As another example, the command recognition controller 104 may generate a command response based on ambient conditions such as, but not limited to, the time of day, the date, the current weather, or forecasted weather conditions (e.g. whether or not it is predicted to rain in the next 12 hours).

As another example, the command recognition controller 104 may generate a command response based on the identities of connected devices 102 that receive the command signals 120. The identities of connected devices 102 (e.g. serial numbers, model numbers, and the like) may be broadcast to the command recognition controller 104 by the connected devices 102 (e.g. via the network 106) or retrieved/requested by the command recognition controller 104. In this regard, one or more connected devices 102 may operate as dedicated control units for one or more additional connected devices 102.

As another example, the command recognition controller 104 may generate a command response based on the locations of connected devices 102 that receive the command signals 120. For example, the command recognition controller 104 may only generate a command response directed to luminaires within a specific room in response to command signals 120 received by connected devices 102 within the same room unless the command signals 120 includes explicit commands to the contrary. Additionally, it may be the case that certain connected devices 102 are unaware of their respective locations, but the command recognition controller 104 may be aware of their locations (e.g. as provided by a user 116).

As another example, the command recognition controller 104 may generate a command response based on the identities of a user 116. The identity of a user 116 may be determined by any technique known in the art including, but not limited to, verbal authentication, voice recognition (e.g. provided by the command recognition controller 104 or an external system), biometric identity recognition (e.g. facial recognition provided by a sensor 128), the presence of an identifying tag (e.g. a Bluetooth or RFID device designating the identity of the user 116), or the like. In this regard, the command recognition controller 104 may generate a different command response upon identification of a command (e.g. by the command module 160) based on the identity of the user 116. For example, the command recognition controller 104, in response to command signals 120 including “watch the news,” may generate control instructions to a television operating as one of the connected devices 102 to turn on different channels based upon the identity of the user 116.

As another example, the command recognition controller 104 may generate a command response based on the location-based contextual attributes of a user 116 such as, but not limited to, location, direction of motion, or intended destination (e.g. associated with a route stored in a GPS device connected to the connected device network 100).

It is noted that the command recognition controller 104 may utilize multiple contextual attributes to generate a command response. For example, the command recognition controller 104 may analyze the location of a user 116 with respect to the locations of one or more connected devices 102. In this regard, the command recognition controller 104 may generate a command response based upon a proximity of a user 116 to one or more connected devices 102 (e.g. as determined by a sensor 128, or the strength of command signals 120 received by a microphone 124). As an example, in response to a user 116 leaving a room at noon and providing command signals 120 including “turn off”, the command recognition controller 104 may generate control instructions directed to connected devices 102 connected to luminaires to turn off the lights. Alternatively, in response to a user 116 leaving a room at midnight and providing command signals 120 including “turn off”, the command recognition controller 104 may generate control instructions directed to all proximate connected devices 102 to turn off connected devices 102 not required in an empty room (e.g. a television, an audio system, a ceiling fan, and the like). As an additional example, in response to a user 116 providing ambiguous command signals 120 including commands associated with more than one device vocabulary 110, the command recognition controller 104 may selectively generate a command response directed to one of the connected devices 102 closest to the user. In this regard, connected devices 102 including a DVR and an audio system playing in different rooms each receive command signals 120 from a user 116 including “fast forward.” The command recognition controller 104 may determine that the user 116 is closer to the audio system and selectively generate a command response to the audio system.

The command module 160 may evaluate a command in light of multiple contexts. For example, it can be determined whether a command makes the most sense if it is interpreted as if being received in a car as opposed to interpreting it as if it occurred in a bedroom or sitting in front of a television.

In another exemplary embodiment, the command recognition controller 104 generates a command response based on one or more rules that may override command signals 120. For example, the command recognition controller 104 may include a rule that a select user 116 (e.g. a child) may not operate selected connected devices 102 (e.g. a television) during a certain timeframe. Accordingly, the command recognition controller 104 may selectively ignore command signals 120 associated with the select user 116 during the designated timeframe. Further, the command recognition controller 104 may include mechanisms to override the rules. Continuing the above example, the select user 116 (e.g. the child) may request authorization from an additional user 116 (e.g. a parent). As an additional example, the command recognition controller 104 may include rules associated with cost. In this regard, connected devices 102 may analyze the cost associated with a command and selectively ignore the command or request authorization to perform the command. For example, the command recognition controller 104 may have a rule designating that selected connected devices 102 may utilize resources (e.g. energy, money, or the like) up to a determined threshold.

In some exemplary embodiments, the command recognition controller 104 includes a micro-aggression module 162 for detecting and/or cataloging micro-aggression associated with a user 116. It is noted that micro-aggression may be manifested in various forms including, but not limited to, disrespectful comments, impatience, aggravation, or key phrases (e.g. asking for a manager, expletives, and the like). A micro-aggression module 162 may identify micro-aggression by analyzing one or more signals associated with connected devices 102 (e.g. a microphone 124, a camera 126, a sensor 128, or the like) transmitted to the command recognition controller 104 (e.g. via the network 106). Further, the micro-aggression module 162 may perform biometric analysis of the user 116 to facilitate the detection of micro-aggression.

Upon detection of micro-aggression by the micro-aggression module 162, the command recognition controller 104 may catalog and archive the event (e.g. by saving relevant signals received from the connected devices 102) for further analysis. Additionally, the command recognition controller 104 may generate a command response (e.g. a control instruction) directed to one or more target connected devices 102. For example, a command recognition controller 104 may generate control instructions to connected devices 102 including a Voice over Internet Protocol (VoIP) device to mask (e.g. sensor) detected micro-aggression instances in real time. As another example, in a customer service context, a micro-aggression module 162 may identify micro-aggression in customers and direct the command module 160 to generate a command response directed to target connected devices 102 (e.g. display devices or alert devices) to facilitate identification of customer mood. In this regard, a micro-aggression module 162 may detect impatience in a user 116 (e.g. a patron) by detecting repeated glances at a clock. Accordingly, the command recognition controller 104 may suggest a reward (e.g. free food) by directing the command module 160 to generate a command response directed to connected devices 102 (e.g. a display device to indicate the user 116 and a recommended reward). As a further example, a command recognition controller 104 may detect micro-aggression in drivers (e.g. through signals detected by connected devices 102 in an automobile analyzed by a micro-aggression module 162) and catalog relevant information (e.g. an image of a license plate or a driver detected by a camera 126) or provide a notification (e.g. to other drivers).

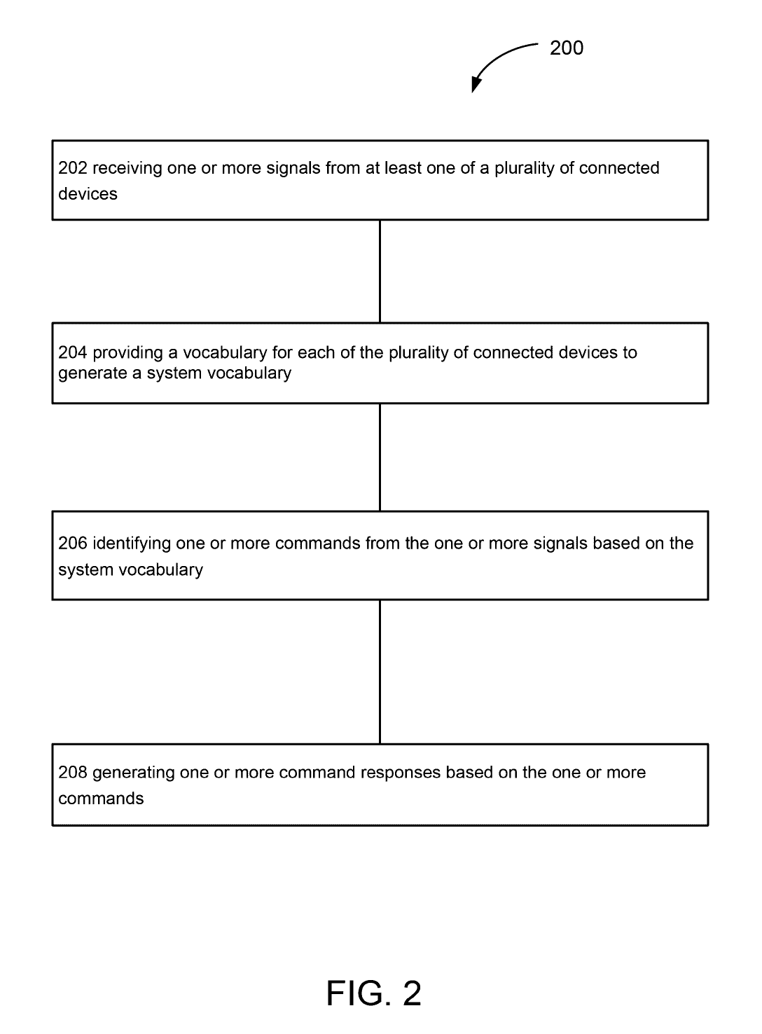

FIG. 2 and the following figures include various examples of operational flows, discussions and explanations may be provided with respect to the above-described exemplary environment of FIGS. 1A and 1B. However, it should be understood that the operational flows may be executed in a number of other environments and contexts, and/or in modified versions of FIGS. 1A and 1B. In addition, although the various operational flows are presented in the sequence(s) illustrated, it should be understood that the various operations may be performed in different sequential orders other than those which are illustrated, or may be performed concurrently.

Further, in the following figures that depict various flow processes, various operations may be depicted in a box-within-a-box manner. Such depictions may indicate that an operation in an internal box may comprise an optional example embodiment of the operational step illustrated in one or more external boxes. However, it should be understood that internal box operations may be viewed as independent operations separate from any associated external boxes and may be performed in any sequence with respect to all other illustrated operations, or may be performed concurrently.

FIG. 2 illustrates an operational procedure 200 for practicing aspects of the present disclosure including operations 202, 204, 206 and 208.

Operation 202 illustrates receiving one or more signals from at least one of a plurality of connected devices. For example, as shown in FIGS. 1A and 1B, one or more signals (e.g. one or more network signals 154 including representations of one or more command signals 120) are received by a command recognition controller 104 from connected devices 102 via a network 106. The one or more command signals 120 (e.g. associated with a user 116) may be received by input hardware 122 of the connected devices 102 (e.g. a microphone 124, a camera 126, a sensor 128, or the like). Further, a device network module 152 associated with one of the connected devices 102 may include a network adapter to translate the network signals 154 according to a defined network protocol for the network 106 so as to enable transmission of the network signals 154 over the network 106. For example, the device network module 152 may include a wired network adapter (e.g. an Ethernet adapter), a wireless network adapter (e.g. a Wi-Fi network adapter), a cellular network adapter, and the like. Further, the network signals 154 may include command signals 120 directly from the input module 118 or command words based on a device vocabulary 110 from a device recognition module 130.

The command recognition controller 104 may receive the network signals 154 from the connected devices 102 via a controller network module 156. For example, the controller network module 156 may include a network adapter (a wired network adapter, a wireless network adapter, a cellular network adapter, and the like) to translate the network signals 154 transmitted across the network 106 according to the network protocol back into the native format (e.g. an audio signal, an image signal, a video signal, one or more identified commands based on a device vocabulary 110, and the like). The data from the controller network module 156 may then be analyzed by the command recognition controller 104.

Operation 204 illustrates determining a vocabulary for each of the plurality of connected devices to generate a system vocabulary. For example, as shown in FIGS. 1A and 1B, each of the connected devices 102 contains a device vocabulary 110 including a database of recognized commands. For example, a device vocabulary 110 may contain commands to perform a function or provide a response (e.g. to a user). For example, a device vocabulary 110 of a television may include commands associated with functions such as, but not limited to powering the television on, powering the television off, selecting a channel, or adjusting the volume.

It may be the case that at least two of the connected devices 102 share a common device vocabulary 110 (e.g. a shared device vocabulary 112). For example, the connected device network 100 includes an intermediary recognition controller 108 including a shared device vocabulary 112 to provide an interface between the connected devices 102 and the command recognition controller 104. In some exemplary embodiments, the command recognition controller 104 generates a system vocabulary 164 based on the device vocabulary 110 of each of the connected devices 102 via a vocabulary module 158. Further, the system vocabulary 114 may include commands from any shared device vocabulary 112 within the connected device network 100. It is noted that generation or update of a system vocabulary 114 may be initiated by the command recognition controller 104 or any connected devices 102. For example, connected devices 102 may broadcast (e.g. via the network 106) a device vocabulary 110 to be associated with a system vocabulary 114. Additionally, a command recognition controller 104 may request and/or retrieve (e.g. via the network 106) any device vocabulary 110 or shared device vocabulary 112. The vocabulary module 158 may further update the system vocabulary 114 based on feedback or direction by a user 116.

Operation 206 illustrates identifying one or more commands from the one or more signals based on the system vocabulary. For example, as shown in FIGS. 1A and 1B, the controller recognition module 146 of a command recognition controller 104 may analyze network signals 154 transmitted via the network 106. For example, the controller recognition module 146 may include a controller speech recognition module 148 and/or a controller gesture recognition module 150 to parse command signals 120 associated with the network signals 154 into distinct words, phrases, sentences, images, static poses, and/or dynamic gestures associated.

Additionally, the command module 160 of the command recognition controller 104 may circuitry to identify one or more commands associated with the system vocabulary 114 based on the parsed output of the controller speech recognition module 148 (or, alternatively, the parsed output of the device recognition module 130 of the connected devices 102 transmitted to the command recognition controller 104 via the network 106). For example, the command module 160 may utilize the output of a controller speech recognition module 148 of the controller recognition module 146 to analyze and interpret speech associated with a user 116 to identify one or more commands based on the system vocabulary 114 provided by the vocabulary module 158.

Operation 208 illustrates generating one or more command responses based on the one or more commands. For example, in FIGS. 1A and 1B, the command module 160 the command module 160 may generate a command response based on the one or more commands associated with the output of the controller recognition module 146. The command response may be of any type known in the art such as, but not limited to, a verbal response, a visual response, or one or more control instructions to one or more connected devices 102. Further, the command recognition controller 104 may transmit the command response via the controller network module 156 over the network 106 to one or more target connected devices 102. In this regard, a command response may include data indicative of one or more notifications to a user (e.g. an audible notification, playback of a recorded signal, and the like), a modification of one or more electronic files located on a storage device (e.g. a to-do list, a calendar appointment, a map, a route associated with a map, and the like), or an actuation of one or more connected devices 102 (e.g. changing the set-point temperature of a thermostat, dimming one or more luminaires, changing the color of a connected luminaire, turning on an appliance, and the like).

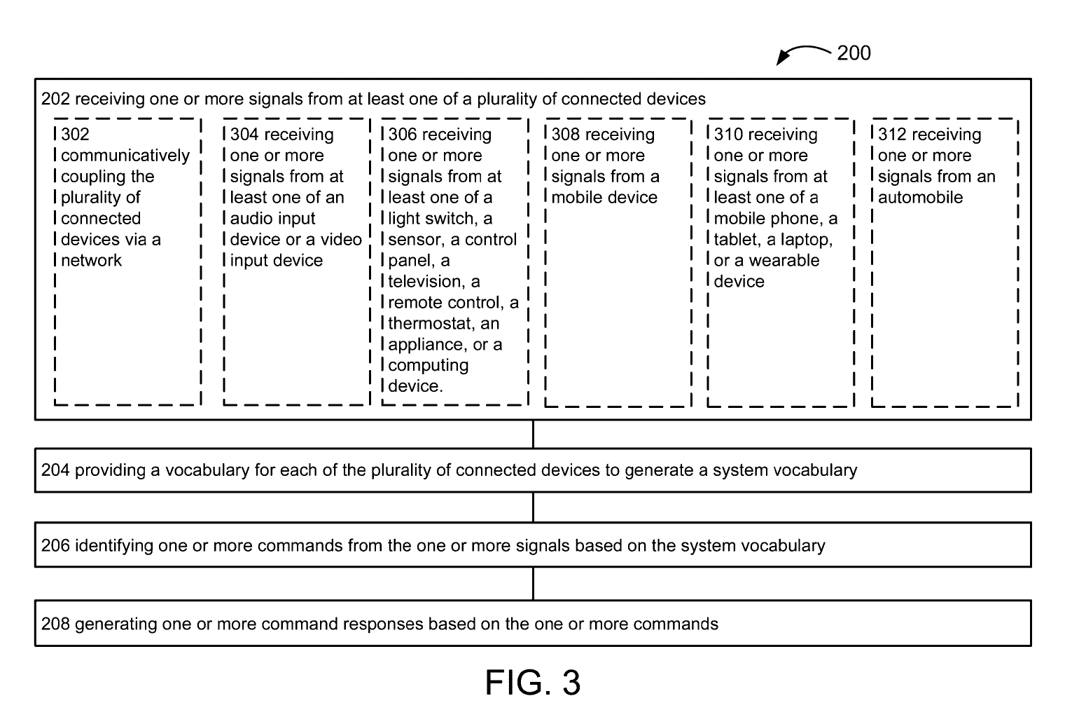

FIG. 3 illustrates an example embodiment where the operation 202 of example operational flow 200 of FIG. 2 may include at least one additional operation. Additional operations may include an operation 302, 304, 306, 308, 310, or 312.

Operation 302 illustrates communicatively coupling the plurality of connected devices via a network. For example, as shown in FIGS. 1A and 1B, one or more connected devices 102 may be connected via a network 106 as part of a connected device network 100. In this regard, connected devices 102 within a connected device network 100 may operate as a distributed network of input devices. Further, any of the connected devices 102 may receive a command intended for any of the other connected devices 102 within the connected device network 100.

The connected devices 102 may communicate, via the device network module 152 via network 106 to any device including, but not limited to, a command recognition controller 104, an intermediary recognition controller 108 and any additional connected devices 102 on the network 106. Similarly, the command recognition controller 104 includes a controller network module 156 for communicating with devices (e.g. the connected devices 102 on the network 106. It is noted that the network 106 may have a variety of topologies including, but not limited to a mesh topology, a ring topology, a star topology, or a bus topology. Further, the topology of the network 106 may change upon the addition or subtraction of connected devices 102. For example, the network 106 may include a wireless mesh topology. Accordingly, devices on the network 106 may include a device network module 152 including a wireless network adapter and an antenna for wireless data communication. Further, network signals 154 may propagate between devices on the network 106 (e.g. between the connected devices 102 and the command recognition controller 104) along any number of paths (e.g. single hop paths or multi-hop paths). In this regard, any device on the network 106 (e.g. the connected devices 102) may serve as repeaters to extend a range of the network 106.

In one exemplary embodiment, a connected device network 100 may include a set of connected devices 102 (e.g. light switches) that communicate across the network 106 via a mesh BLE protocol, a set of connected devices 102 (e.g. a thermostat and one or more connected appliances) that communicate across the network 106 via a Wi-Fi protocol, a set of connected devices 102 (e.g. media equipment) that communicate across the network 106 via a wired Ethernet protocol, a set of connected devices 102 (e.g. sensors) that communicate to an intermediary recognition controller 108 (e.g. a hub) via a proprietary wireless protocol, which further communicates across the network 106 via a wired Ethernet protocol, and a set of connected devices 102 (e.g. mobile devices) that communicate across the network 106 via a cellular network protocol.

Operation 304 illustrates receiving one or more signals from at least one of an audio input device or a video input device. For example, as shown in FIGS. 1A and 1B, connected devices 102 may receive one or more signals (e.g. one or more command signals 120 associated with a user 116) through input hardware 122 (e.g. a microphone 124, camera 126, sensor 128 or the like). The input hardware 122 may include a microphone 124 to receive speech generated by the user 116. The input hardware 122 may additionally include a camera 126 to receive image data and/or video data representative of a user 116 or the environment proximate to the connected devices 102. In this regard, a camera 126 may capture command signals 120 including data indicative of an image of the user 116 and/or one or more stationary poses or moving gestures indicative of one or more commands. Further, the input hardware 122 may include a sensor 128 to receive data associated with the user 116. In this regard, a sensor 128 may include, but is not limited to, a motion sensor, a physiological sensor (e.g. for facial recognition, eye tracking, or the like).

Operation 306 illustrates receiving one or more signals from at least one of a light switch, a sensor, a control panel, a television, a remote control, a thermostat, an appliance, or a computing device. For example, as shown in FIGS. 1A and 1B, connected devices 102 may include any type of device connected directly or indirectly to the command recognition controller 104 as part of the connected device network 100. In this regard, connected devices 102 may include a light switch (e.g. a light switch configured to control the power and/or brightness of one or more luminaires in response to control instructions provided by the command recognition controller 104), a sensor (e.g. a motion sensor, an occupancy sensor, a door/window sensor, a thermometer, a humidity sensor, a light sensor, and the like), a control panel (e.g. a device panel configured to control one or more connected devices 102), a remote control (e.g. a portable control panel), a thermostat (e.g. a connected thermostat, or alternatively any connected climate control device such as a humidifier), an appliance (e.g. a television, a refrigerator, a Bluetooth speaker, an audio system, and the like) or a computing device (e.g. a personal computer, a laptop computer, a local server, a remote server, and the like).

Operation 308 illustrates receiving one or more signals from a mobile device. The controller network module 156 or any device network module 152 may include one or more adapters to facilitate wireless communication with a mobile device via the network 106. For example, the controller network module 156 or any device network module 152 may utilize any protocol known in the art such as, but not limited to, cellular, Wi-Fi, Bluetooth, Bluetooth Low Energy (BLE), Zigbee, Z-Wave, or Thread. It may be the case that the controller network module 156 or any device network module 152 may utilize multiple communication protocols. Operation 310 illustrates receiving one or more signals from at least one of a mobile phone, a tablet, a laptop, or a wearable device. For example, the command recognition controller 104 may receive one or more signals (e.g. network signals 154) from mobile devices such as, but not limited to, a mobile phone (e.g. a cellular phone, a Bluetooth device connected to a phone, and the like), a tablet (e.g. an Apple iPad, a Samsung Galaxy Tab, a Microsoft Surface, and the like), a laptop (e.g. an Apple MacBook, a Toshiba Satellite, and the like), or a wearable device (e.g. an Apple Watch, a Fitbit, and the like).

Operation 312 illustrates receiving one or more signals from an automobile. For example, a command recognition controller 104 may receive signals from any type of automobile including, but not limited to a sedan, a sport utility vehicle, a van, or a crossover utility vehicle.

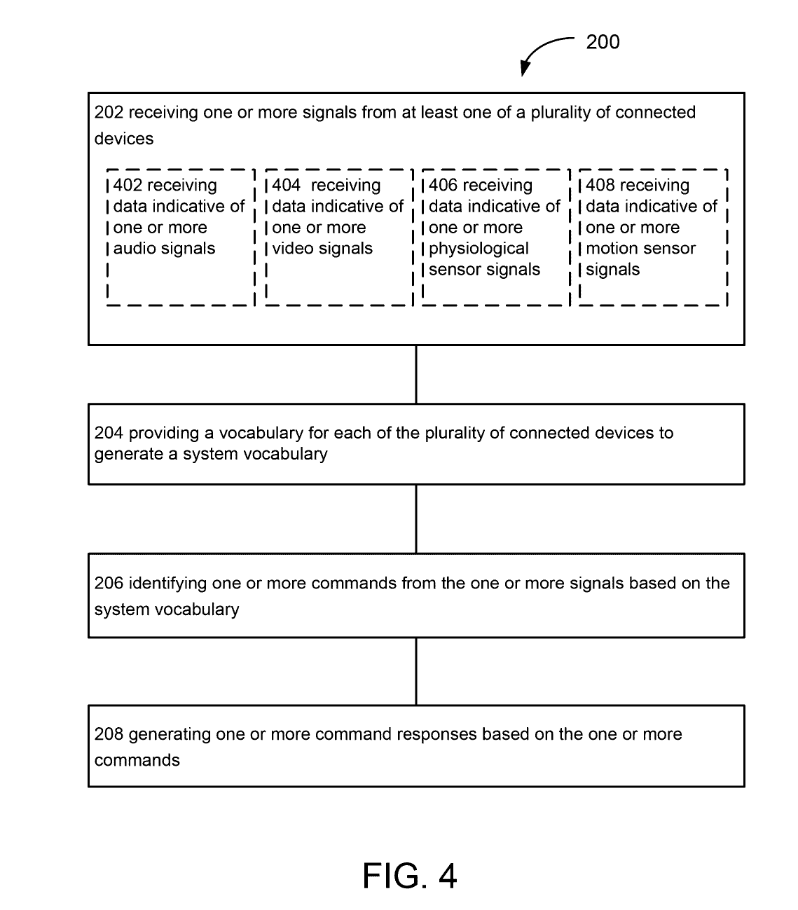

FIG. 4 illustrates an example embodiment where the operation 202 of example operational flow 200 of FIG. 2 may include at least one additional operation. Additional operations may include an operation 402, 404, 406, or 408.

Operation 402 illustrates receiving data indicative of one or more audio signals. For example, as shown in FIGS. 1A and 1B, a command recognition controller 104 may receive one or more audio signals (e.g. via a microphone 124). Further, the one or more audio signals may include, but are not limited to, speech associated with a user 116 (e.g. one or more words, phrases, or sentences indicative of a command), or ambient sounds present in a location proximate to the microphone 124.

Operation 404 illustrates receiving data indicative of one or more video signals. For example, as shown in FIGS. 1A and 1B, a command recognition controller 104 may receive one or more video signals (e.g. via a camera 126). Further, the one or more video signals may include, but are not limited to, still images, or continuous video signals.

Operation 406 illustrates receiving data indicative of one or more physiological sensor signals. For example, as shown in FIGS. 1A and 1B, a command recognition controller 104 may receive one or more physiological sensor signals (e.g. via a sensor 128, a microphone 124, a camera 126, or the like). Physiological sensor signals may include, but are not limited to biometric recognition signals (e.g. facial recognition signals, retina recognition signals, fingerprint recognition signals, and the like), eye-tracking signals, signals indicative of micro-aggression, signals indicative of impatience, perspiration signals, or heart-rate signals (e.g. from a wearable device).

Operation 408 illustrates receiving data indicative of one or more motion sensor signals. For example, as shown in as shown in FIGS. 1A and 1B, a command recognition controller 104 may receive one or more motion sensor signals (e.g. via a sensor 128, a microphone 124, a camera 126, or the like) such as, but not limited to, infrared sensor signals, occupancy sensor signals, radar signals, or ultrasonic motion sensing signals.

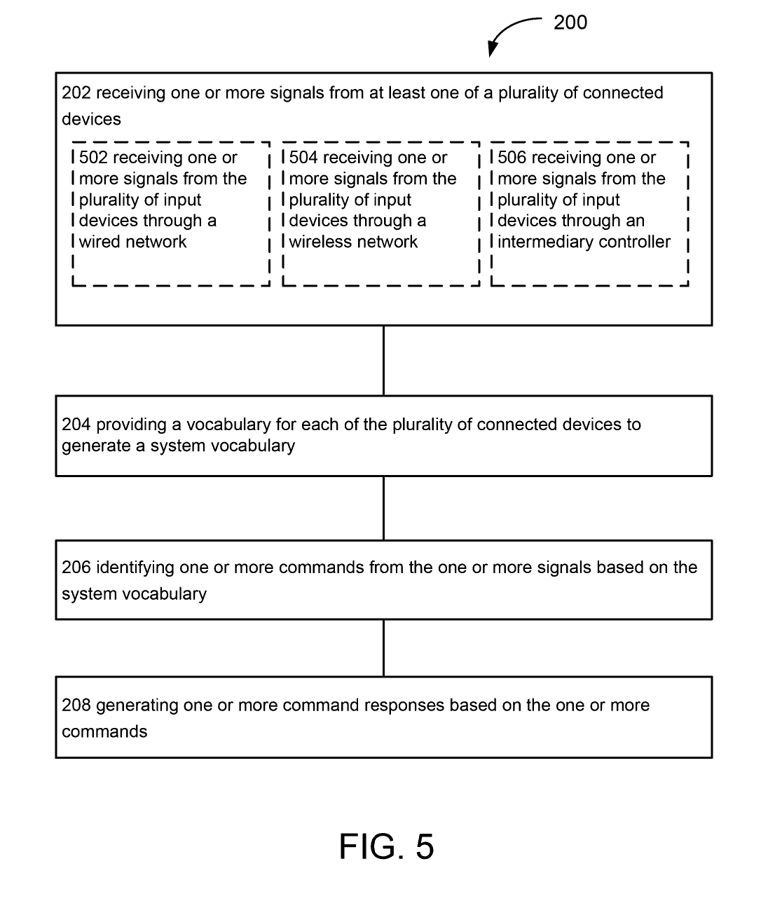

FIG. 5 illustrates an example embodiment where the operation 202 of example operational flow 200 of FIG. 2 may include at least one additional operation. Additional operations may include an operation 502, 504, or 506.

Operation 502 illustrates receiving one or more signals from the plurality of input devices through a wired network. For example, the controller network module 156 or any device network module 152 may include one or more adapters to facilitate wired communication via the network 106. For example, the controller network module 156 or any device network module 152 may utilize, but is not limited to, an Ethernet adapter, or a powerline adapter (e.g. an adapter configured to transmit and/or receive data along electrical wires providing electrical power).

Operation 504 illustrates receiving one or more signals from the plurality of input devices through a wireless network. For example, the controller network module 156 or any device network module 152 may include one or more adapters to facilitate wireless communication via the network 106. Accordingly, devices on the network 106 may include a device network module 152 including a wireless network adapter and an antenna for wireless data communication. Further, the network 106 (e.g. a wireless network) may have any topology known in the art including, but not limited to a mesh topology, a ring topology, a star topology, or a bus topology. For example, the network 106 may include a wireless mesh topology. In this regard, network signals 154 may propagate between devices on the network 106 (e.g. between the connected devices 102 and the command recognition controller 104) along any number of paths (e.g. single hop paths or multi-hop paths). In this regard, any device on the network 106 (e.g. the connected devices 102) may serve as repeaters to extend a range of the network 106.

Operation 506 illustrates receiving one or more signals from the plurality of input devices through an intermediary controller. For example, as shown in FIGS. 1A and 1B, a connected device network 100 may include an intermediary recognition controller 108 to provide connectivity between the command recognition controller 104 and one or more of the connected devices 102. Further, the intermediary recognition controller 108 may provide a hierarchy of recognition of commands received by the connected devices 102. For example, an intermediary recognition controller 108 may contain a shared device vocabulary 112 associated with similar connected devices 102 (e.g. connected devices 102 from a common brand). In this regard, an intermediary recognition controller 108 may operate as a hub. Additionally, an intermediary recognition controller 108 may provide an additional level of recognition operations (e.g. speech recognition and/or gesture recognition) between connected devices 102 and the command recognition controller 104.

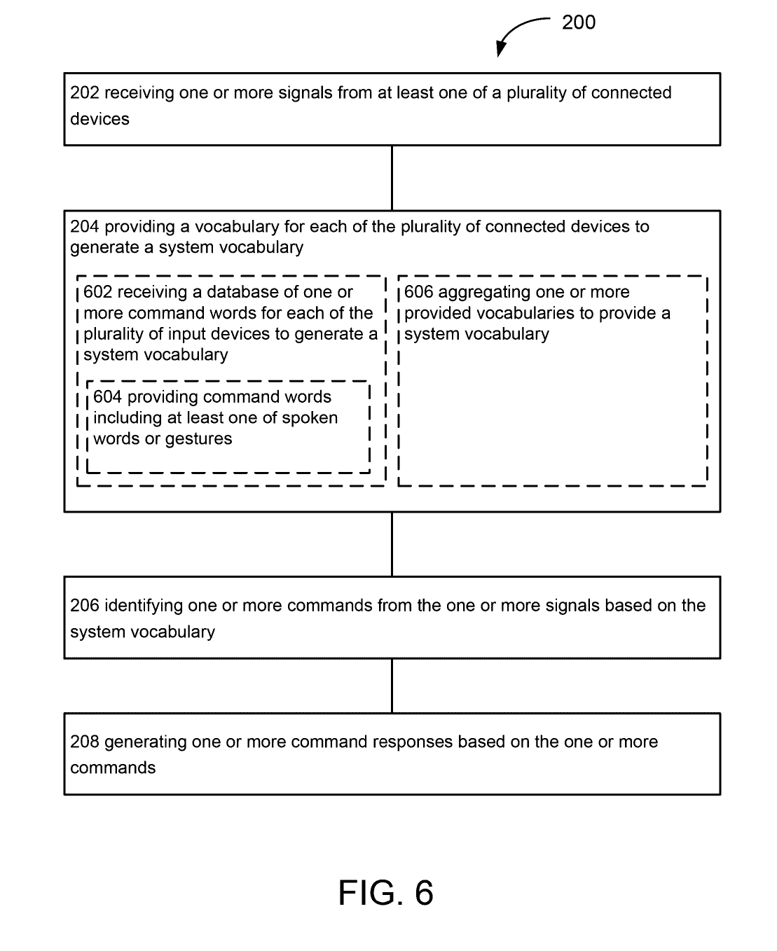

FIG. 6 illustrates an example embodiment where the operation 204 of example operational flow 200 of FIG. 2 may include at least one additional operation. Additional operations may include an operation 602, 604, or 606.

Operation 602 illustrates receiving one or more command words for each of the plurality of input devices to generate a system vocabulary. For example, as shown in FIGS. 1A and 1B, the command recognition controller 104 generates a system vocabulary 114 using the vocabulary module 158 based on the device vocabulary 110 of each of the connected devices 102. Further, the system vocabulary 114 may include commands from any shared device vocabulary 112 within the connected device network 100. In this regard, the command recognition controller 104 may identify one or more commands and/or issue control instructions associated with any of the connected devices 102 within the connected device network 100.

The vocabulary module 158 may update the system vocabulary 114 based on the available connected devices 102. For example, the command recognition controller 104 may periodically poll the connected device network 100 to identify any connected devices 102 and direct the vocabulary module 158 to add commands to or remove commands from the system vocabulary 114 accordingly. As another example, the command recognition controller 104 may update the system vocabulary 114 with a device vocabulary 110 of all newly discovered connected devices 102.

Operation 604 illustrates providing command words including at least one of spoken words or gestures. A system vocabulary 114 may contain a database of recognized commands associated with each of the connected devices 102. Further, a command may include on or more command words. It is noted that a command word may include spoken words or gestures (e.g. static pose gestures or dynamic gestures involving motion). For example, a command words associated with the system vocabulary 114 may include action words (speech or gestures) such as, but not limited to “power,” “adjust,” “turn,” “off,” “on”, “up,” “down,” “all,” or “show me.” Additionally, command words associated with the system vocabulary 114 may include identifiers such as, but not limited to “television,” “lights,” “thermostat,” “temperature,” or “car.” It is noted herein that the description and examples of command words above is provided solely for illustrative purposes and should not be interpreted as limiting.

Operation 606 illustrates aggregating one or more provided vocabularies to provide a system vocabulary. The generation or an update of a system vocabulary 114 may be initiated by the command recognition controller 104 or any connected devices 102. For example, connected devices 102 may broadcast (e.g. via the network 106) a device vocabulary 110 to be associated with a system vocabulary 114. Additionally, a command recognition controller 104 may request and/or retrieve (e.g. via the network 106) any device vocabulary 110 or shared device vocabulary 112. The vocabulary module 158 of the command recognition controller 104 may subsequently aggregate the provided vocabularies (e.g. the connected devices 102) to a system vocabulary 114.

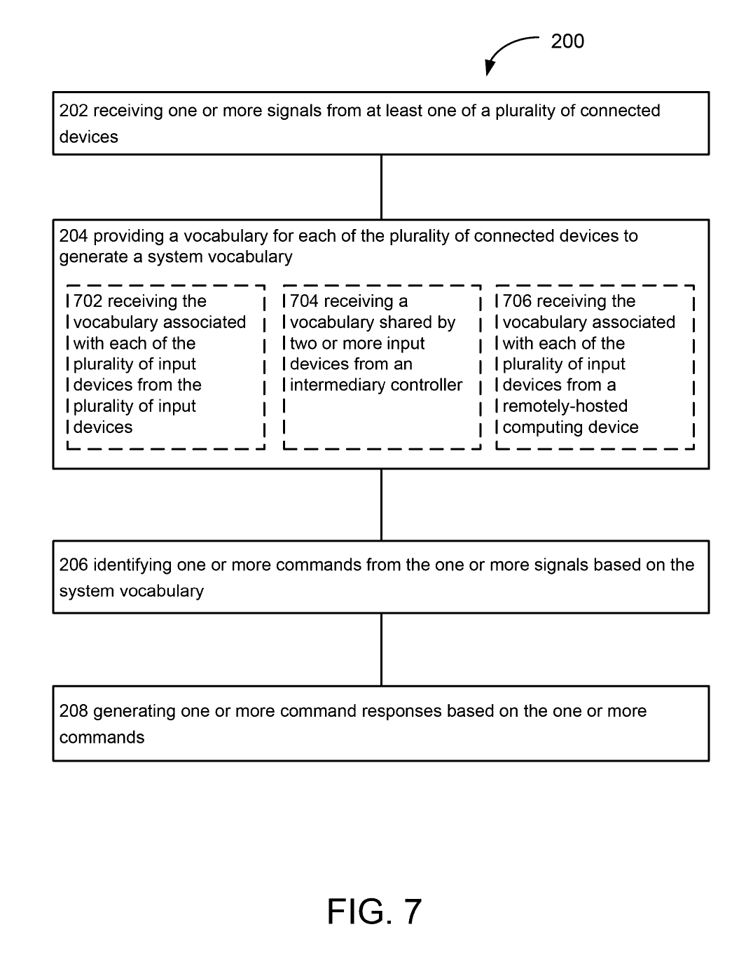

FIG. 7 illustrates an example embodiment where the operation 204 of example operational flow 200 of FIG. 2 may include at least one additional operation. Additional operations may include an operation 702, 704, or 706.

Operation 702 illustrates receiving the vocabulary associated with each of the plurality of connected devices from the connected of input devices. For example, connected devices 102 may broadcast (e.g. via the network 106) a device vocabulary 110 to be associated with a system vocabulary 114. In this regard, a command recognition controller 104 may receive a device vocabulary 110 associated with each of the connected devices 102 via the vocabulary module 158 through the controller network module 156.

Operation 704 illustrates receiving a vocabulary shared by two or more input devices from an intermediary controller. For example, as shown in FIGS. 1A and 1B, multiple connected devices 102 communicatively coupled with an intermediary recognition controller 108 may share a common device vocabulary 110 (e.g. a shared device vocabulary 112. For example, an intermediary recognition controller 108 may operate as a hub for a family of connected devices 102 (e.g. a family of light switches, connected luminaires, sensors, and the like) that communicate via a common protocol and utilize a common set of commands (e.g. a shared device vocabulary 112). Further, a connected device network 100 may include more than one intermediary recognition controller 108. In this regard, a connected device network 100 may provide a unified platform for multiple families of connected devices 102.

Operation 706 illustrates receiving the vocabulary associated with each of the plurality of input devices from a remotely-hosted computing device. It may be the case that a device vocabulary 110 associated with one or more connected devices 102 may be provided by a remotely-hosted computing device (e.g. a remote server). For example, a remote server may maintain an updated version of a device vocabulary 110 that may be received by the command recognition controller 104, an intermediary recognition controller 108, or the connected devices 102.

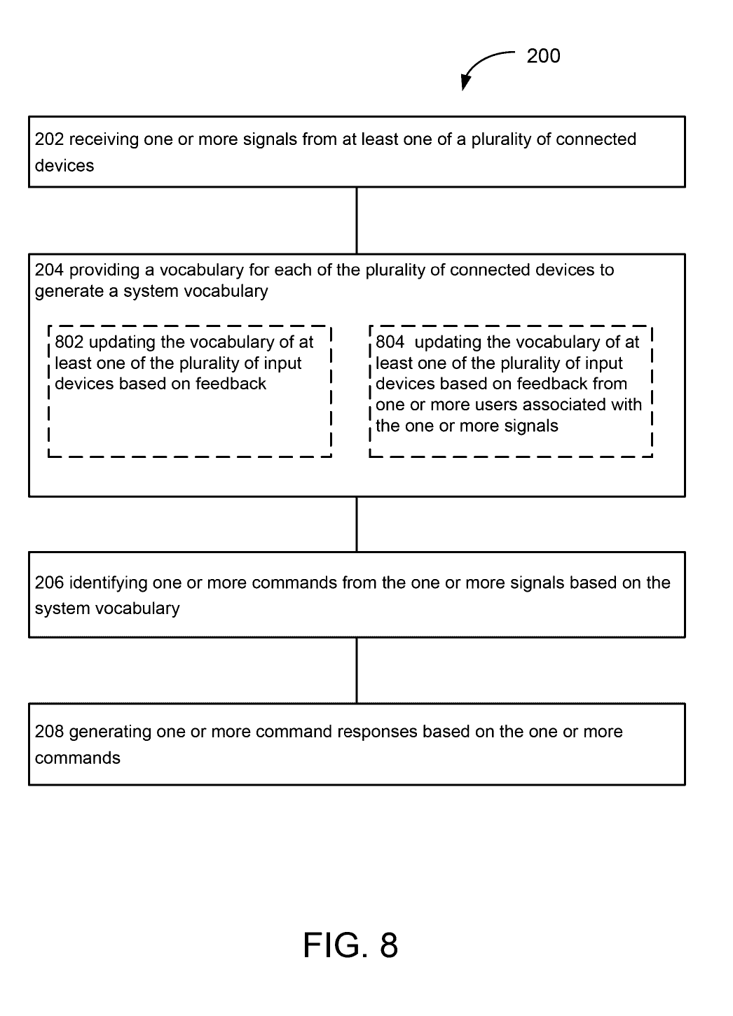

FIG. 8 illustrates an example embodiment where the operation 204 of example operational flow 200 of FIG. 2 may include at least one additional operation. Additional operations may include an operation 802 or 804.

Operation 802 illustrates updating the vocabulary of at least one of the plurality of input devices based on feedback. For example, the command recognition controller 104 may adapt to identify one or more commands associated with the system vocabulary 114 based on feedback. For example, the command recognition controller 104 may adaptively learn idiosyncrasies of a user 116 in order to update the system vocabulary 114 by the vocabulary module 158. In this regard, a system vocabulary 114 may be personalized for a user 116.

Operation 804 illustrates updating the vocabulary of at least one of the plurality of input devices based on feedback from one or more users associated with the one or more signals. For example, the vocabulary module 158 may update the system vocabulary 114 based on feedback or direction by a user 116. In this regard, a user 116 may define a subset of commands associated with the system vocabulary 114 to be inactive. As an illustrative example, a connected device network 100 may include multiple connected devices 102 having “power off” as a command word associated with each device vocabulary 110. A user 116 may deactivate one or more commands within the system vocabulary 114 to mitigate ambiguity (e.g. only a single “power off” command word is activated). Additionally, the user 116 may modify the system vocabulary 114 to require additional information not required by a device vocabulary 110. For example, a connected device network 100 may include multiple connected devices 102 having “power off” as a command word associated with each device vocabulary 110. The vocabulary module 158 may update the system vocabulary 114 to include a device identifier (e.g. “power television off”) to mitigate ambiguity.

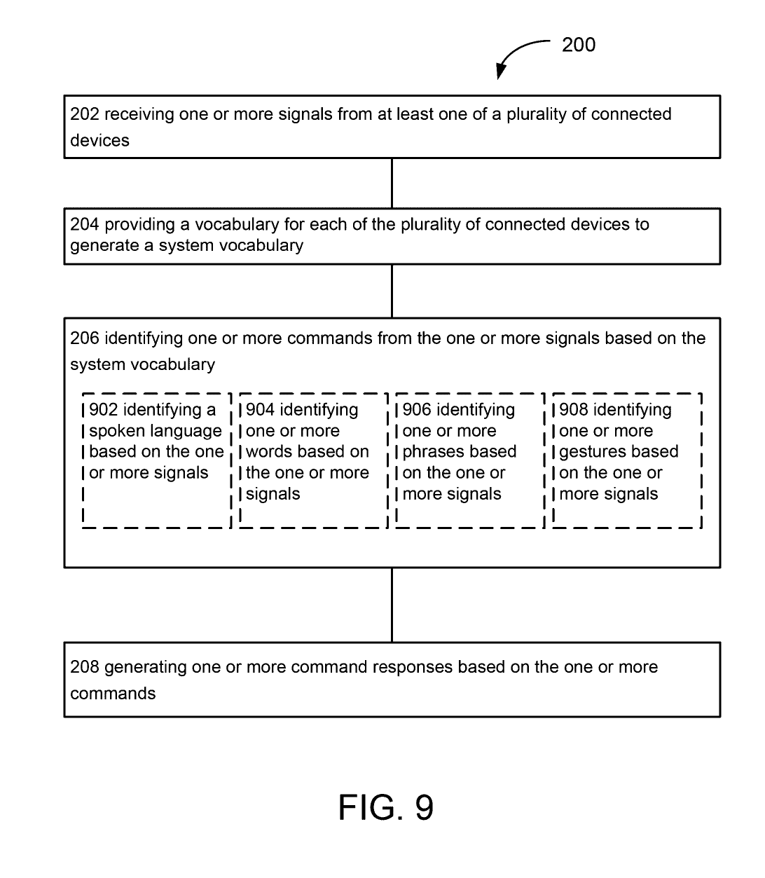

FIG. 9 illustrates an example embodiment where the operation 206 of example operational flow 200 of FIG. 2 may include at least one additional operation. Additional operations may include an operation 902, 904, 906, or 908. For example,

FIG. 902 illustrates identifying a spoken language based on the one or more signals. For example, the command recognition controller 104 may include circuitry to identify a spoken language (e.g. English, German, Spanish, French, Mandarin, Japanese, and the like) based on the command signals 120 and/or output from a controller speech recognition module 148. Further, a command recognition controller 104 may identify one or more commands based on the identified language. In this regard, one or more command signals 120 in any language understandable by the command recognition controller 104 may be mapped to one or more commands associated with the system vocabulary 114 (e.g. the system vocabulary 114 itself may be language agnostic). Additionally, a command recognition controller 104 may extend the language-processing functionality of connected devices 102 in the connected device network 100. For example, a command recognition controller 104 may supplement, expand, or enhance speech recognition functionality (e.g. provided by a device recognition module 130) of connected devices 102 (e.g. FireTV, and the like).

Operation 904 illustrates identifying one or more words based on the one or more signals. Operation 906 illustrates identifying one or more phrases based on the one or more signals Operation 908 illustrates identifying one or more gestures based on the one or more signals. For example, the device recognition module 130 may include circuitry for speech and/or gesture recognition for processing the command signals 120 to identify one or more commands based on the device vocabulary 110. More specifically, a device recognition module 130 may include circuitry to parse command signals 120 into distinct words, phrases, sentences, images, static poses, and/or dynamic gestures and may further include circuitry to analyze the parsed words, phrases, sentences, images, static poses, and/or dynamic gestures to identify one or more command words associated with a device vocabulary 110. Additionally, an intermediary controller recognition module 138 or a controller recognition module 146 may identify one or more words, phrases, or gestures based on one or more network signals 154 received over the network 106 from the connected devices 102 (e.g. including command signals 120 from the input module 118, data from the device recognition module 130 (e.g. parsed speech and/or gestures), or data from the device command module 136 (e.g. one or more commands).

It may be the case that the connected devices 102 may lack sufficient processing power to perform recognition operations (e.g. speech recognition and/or gesture recognition). Accordingly, not all of the connected devices 102 include a device recognition module 130. The connected devices 102 may transmit all or a portion of command signals 120 captured by input hardware 122 to a controller in the connected device network 100 (e.g. an intermediary recognition controller 108 or a command recognition controller 104) for recognition operations. Accordingly, as shown in FIG. 1B, an intermediary controller recognition module 138 may include an intermediary speech recognition module 140 and/or an intermediary gesture recognition module 142 for parsing command signals 120 into distinct words, phrases, sentences, images, static poses, and/or dynamic gestures. Similarly, a controller recognition module 146 may include a controller speech recognition module 148 and/or a controller gesture recognition module 150 for similarly parsing command signals 120 into distinct words, phrases, sentences, images, static poses, and/or dynamic gestures.

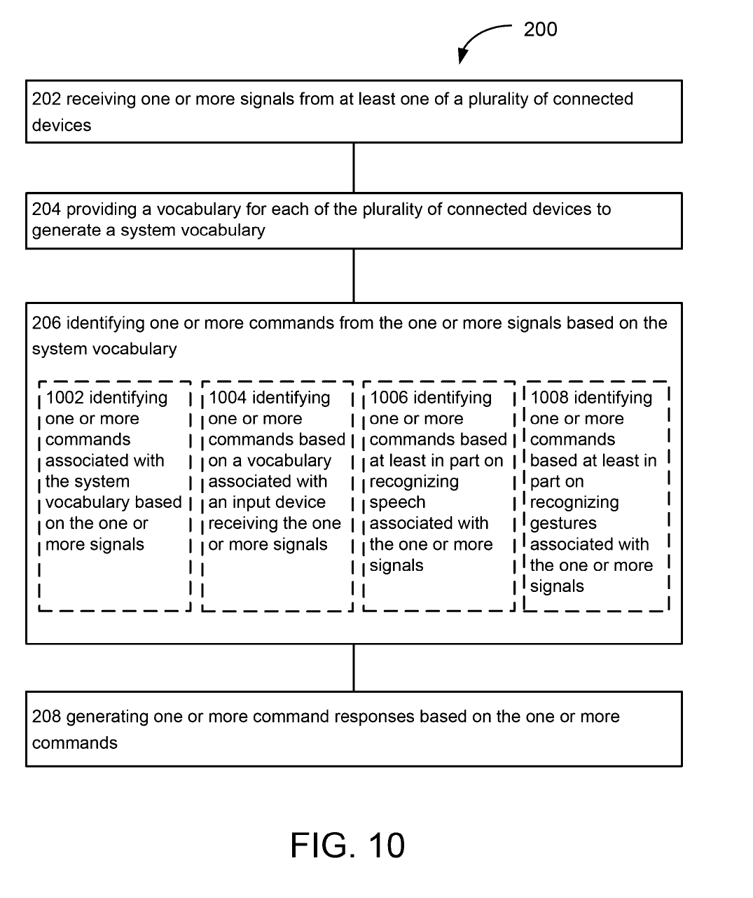

FIG. 10 illustrates an example embodiment where the operation 206 of example operational flow 200 of FIG. 2 may include at least one additional operation. Additional operations may include an operation 1002, 1004, 1006, or 1008.

Operation 1002 illustrates identifying one or more commands associated with the system vocabulary based on the one or more signals. A vocabulary module 158 of a command recognition controller 104 may analyze the output of the controller recognition module 146 (e.g. a string of recognized words associated with the command signals 120 and transmitted as network signals 154 to the controller speech recognition module 148) to determine one or more commands comprising one or more command words. It is noted that a command may include on or more command words. It is noted that a command word may include spoken words or gestures (e.g. static pose gestures or dynamic gestures involving motion). For example, a command words associated with the system vocabulary 114 may include action words (speech or gestures) such as, but not limited to “power,” “adjust,” “turn,” “off,” “on”, “up,” “down,” “all,” or “show me.” Additionally, command words associated with the system vocabulary 114 may include identifiers such as, but not limited to “television,” “lights,” “thermostat,” “temperature,” or “car.” In this regard, a command may include one or more command words (e.g. “turn off all of the lights”). Similarly, gestures may include, but are not limited to, a configuration of a hand, a motion of a hand, standing up, sitting down, or walking in a specific direction. It is noted herein that the description and examples of command words above is provided solely for illustrative purposes and should not be interpreted as limiting.

Operation 1004 illustrates identifying one or more commands based on a vocabulary associated with an input device receiving the one or more signals. For example, it may be the case that a command may be associated with a device vocabulary 110 of multiple connected devices 102 (e.g. “power off”, “power on”, and the like). In such cases, the vocabulary module 158 of the command recognition controller 104 may, but is not limited to, identify or otherwise interpret one or more commands based on which of the connected devices 102 receive the command (e.g. via one or more command signals 120). In the case that multiple input devices receive the command, the controller may determine which of the connected devices 102 is closest to the user 116 and identify one or more commands based on the corresponding device vocabulary 110.

Operation 1006 illustrates identifying one or more commands based at least in part on recognizing speech associated with the one or more signals. Operation 1008 illustrates identifying one or more commands based at least in part on recognizing gestures associated with the one or more signals. It may be the case that a user 116 does not provide a verbatim recitation of a command (e.g. via command signals 120) associated with the system vocabulary 114 (e.g. a word, a phrase, a sentence, a static pose, or a dynamic gesture). Accordingly, the command module 160 may include circuitry (e.g. statistical analysis circuitry) to analyze components of the output of the controller recognition module 146 or the command signals 120 directly to identify one or more commands.

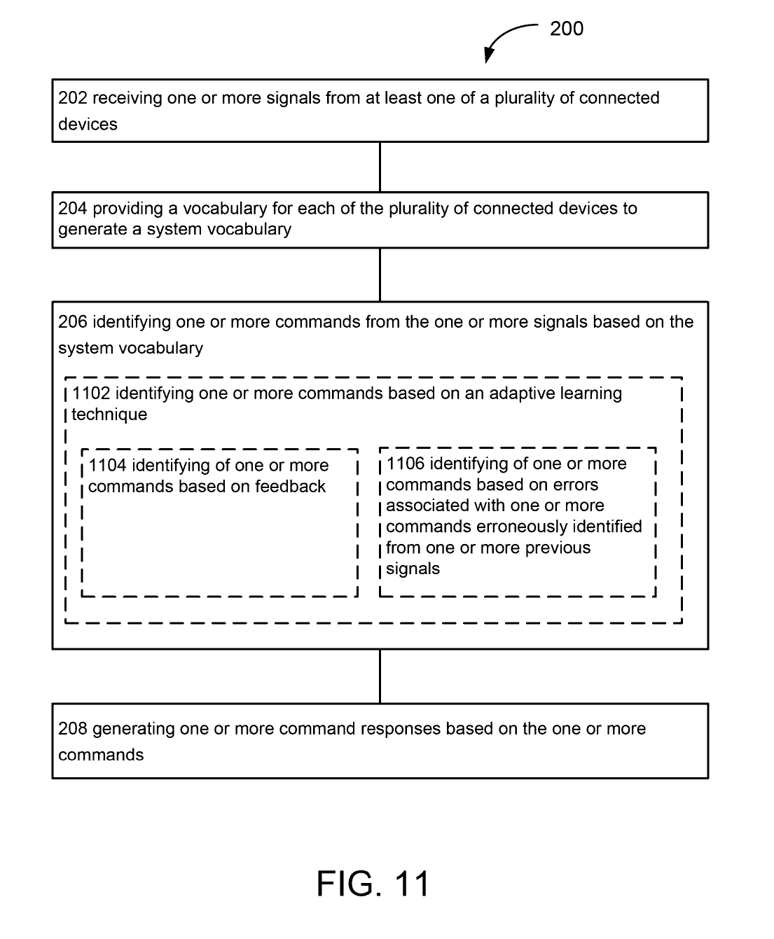

FIG. 11 illustrates an example embodiment where the operation 206 of example operational flow 200 of FIG. 2 may include at least one additional operation. Additional operations may include an operation 1102, 1104, or 1106.

Operation 1102 illustrates identifying one or more commands based on an adaptive learning technique. The command recognition controller 104 may catalog and analyze commands (e.g. command signals 120) provided to the connected device network 100. Further, the command recognition controller 104 may utilize an adaptive learning technique to identify one or more commands based on the analysis of previous commands. For example, if all of the connected devices 102 (e.g. luminaires, televisions, audio systems, and the like) are turned off at 11 PM every night, the command module 160 of the command recognition controller 104 may learn to identify a command (e.g. “turn off the lights”) as broader than explicitly provided and may subsequently identify commands to power off all connected devices 102.

Operation 1104 illustrates identifying of one or more commands based on feedback. For example, the command recognition controller 104 may adapt to identify one or more commands associated with the system vocabulary 114 based on feedback from a user 116. In this regard, a user 116 may indicate that a command response generated by the command recognition controller 104 was inaccurate. As an illustrative example, a user may first provide command signals 120 including commands to “turn off the lights.” In response, the command recognition controller 104 may turn off all connected devices 102 configured to control luminaires. Further, a user 116 may provide feedback (e.g. additional command signals 120) such as “no, leave the hallway light on.”

Operation 1106 illustrates identifying of one or more commands based on errors associated with one or more commands erroneously identified from one or more previous signals. It may be the case that a command recognition controller 104 may erroneously identify one or more commands associated with command signals 120 received by input hardware 122. In response, a user 116 may provide corrective feedback.

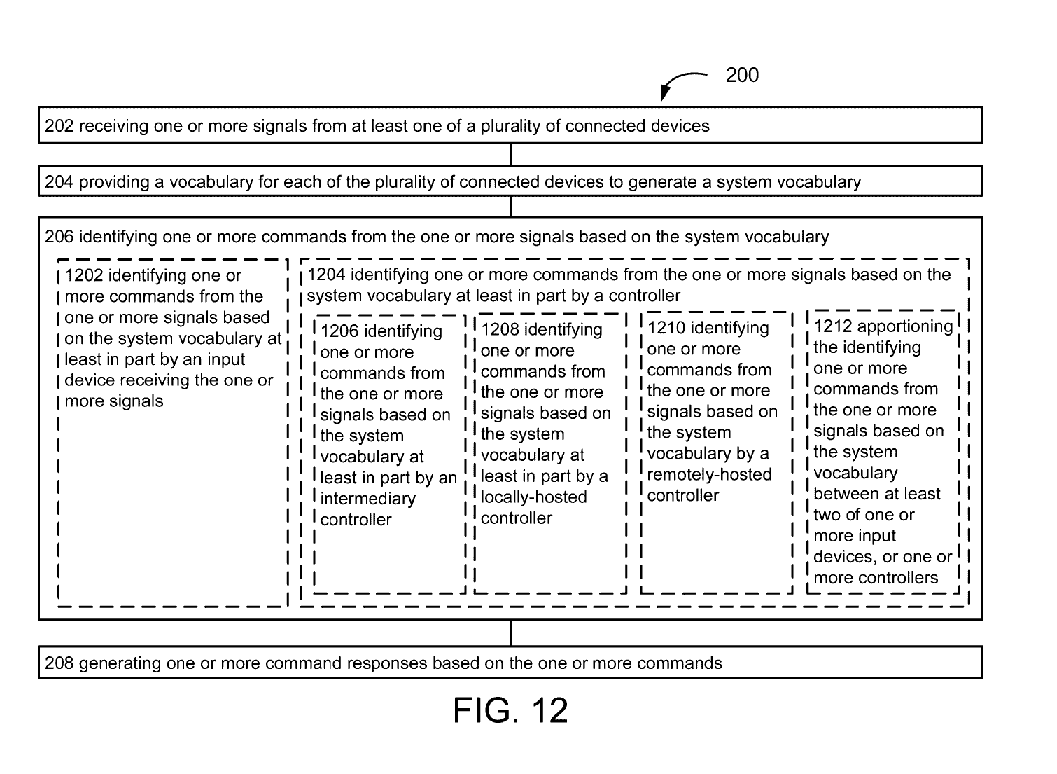

FIG. 12 illustrates an example embodiment where the operation 206 of example operational flow 200 of FIG. 2 may include at least one additional operation. Additional operations may include an operation 1202, 1204, or 1206.

Operation 1202 illustrates identifying one or more commands from the one or more signals based on the system vocabulary at least in part by an input device receiving the one or more signals. For example, as shown in FIGS. 1A and 1B, the connected devices 102 may include a device command module 136 to identify one or more commands based on the device vocabulary 110. For example, a device command module 136 may receive the output of the device recognition module 130 (e.g. one or more words, phrases, sentences, static poses, dynamic gestures, and the like) to identify one or more commands based on the device vocabulary 110. In this regard, the connected devices 102 may provide recognition services (e.g. speech and/or gesture recognition). Further, commands identified by the device recognition module 130 may be transmitted (e.g. via the network 106) to the command recognition controller 104 for additional processing based on the system vocabulary 114. In this regard, the connected devices 102, each containing a device vocabulary 110, may supplement the identification of one or more commands based on the system vocabulary 114.

Operation 1204 illustrates identifying one or more commands from the one or more signals based on the system vocabulary at least in part by a controller. For example, as shown in FIGS. 1A and 1B, the command module 160 associated with a command recognition controller 104 may identify one or more commands based on the system vocabulary 114. The command module 160 may identify one or more commands based on the output of the controller recognition module 146 (e.g. a controller speech recognition module 148 or a controller gesture recognition module 150). Additionally, the command module 160 may identify one or more commands based on one or more network signals 154 associated with the connected devices 102 (e.g. command signals 120 from the input module 118, data from the device recognition module 130 or data from the device command module 136). In this regard, the command recognition controller 104 may identify one or more commands based on the system vocabulary 114 with optional assistance from the connected devices 102.

Operation 1206 illustrates identifying one or more commands from the one or more signals based on the system vocabulary at least in part by an intermediary controller. For example, as shown in FIGS. 1A and 1B, an intermediary controller recognition module 138 may include an intermediary speech recognition module 140 and/or an intermediary gesture recognition module 142 for parsing command signals 120 into distinct words, phrases, sentences, images, static poses, and/or dynamic gestures. An intermediary recognition controller 108 may receive network signals 154 (e.g. command signals 120, parsed speech and/or gestures, or commands) from the connected devices 102. Further, commands identified by the intermediary controller recognition module 138 may be transmitted (e.g. via the network 106) to the command recognition controller 104 for additional processing based on the system vocabulary 114. In this regard, the intermediary recognition controller 108, containing a shared device vocabulary 112, may supplement the identification of one or more commands based on the system vocabulary 114.

Operation 1208 illustrates identifying one or more commands from the one or more signals based on the system vocabulary at least in part by a locally-hosted controller. For example, any controller (e.g. an intermediary recognition controller 108 or a command recognition controller 104) may be locally-hosted (e.g. on the same local area network or in close physical proximity to the connected devices 102.

Operation 1210 illustrates identifying one or more commands from the one or more signals based on the system vocabulary by a remotely-hosted controller. For example, any controller (e.g. an intermediary recognition controller 108 or a command recognition controller 104) may be remotely-hosted (e.g. accessible via the internet). In this regard, the controllers need not be on the same local network (e.g. local area network) as the connected devices 102 and may rather be located at any convenient location.

Operation 1212 illustrates apportioning the identifying one or more commands from the one or more signals based on the system vocabulary between at least two of one or more input devices, or one or more controllers. For example, a connected device network 100 may include more than one controller (e.g. more than one command recognition controller 104 and/or more than one intermediary recognition controller 108). For example, a command received by connected devices 102 may be sent to a local controller or a remote controller either in sequence or in parallel. In this regard, “speech-as-a-service” or “gesture-as-a-service” operations may be escalated to any level (e.g. a local level or a remote level) based on need. Additionally, it may be the case that a remote-level controller may provide more functionality (e.g. more advanced speech/gesture recognition, a wider information database, and the like) than a local controller. In some exemplary embodiments, a command recognition controller 104 may communicate with an additional command recognition controller 104 or any remote host (e.g. the internet) to perform a task.

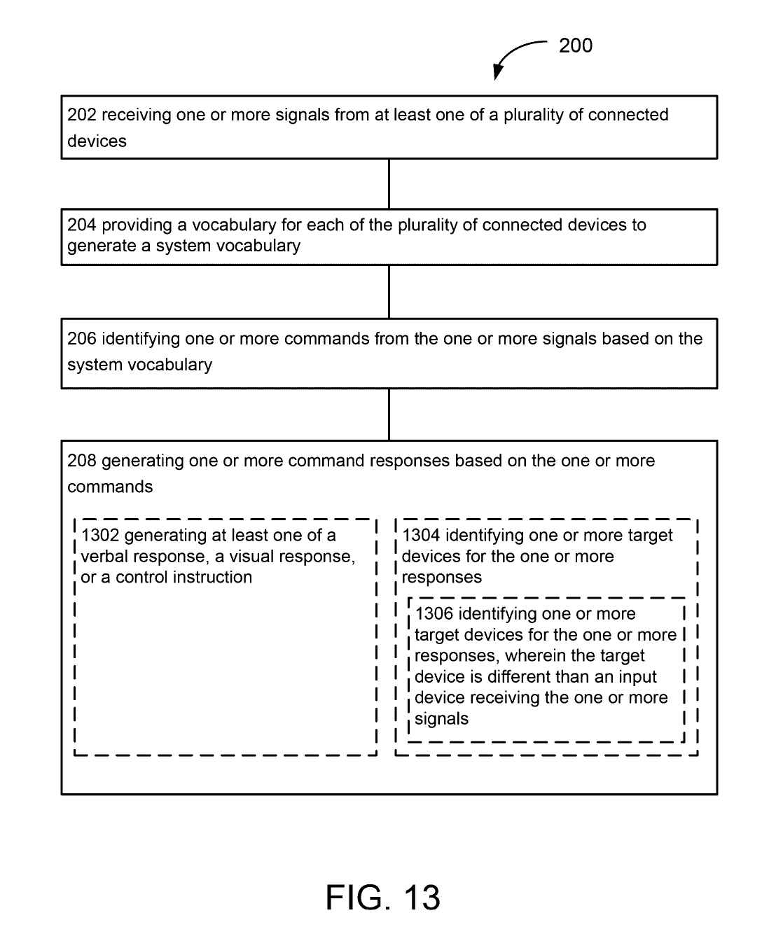

FIG. 13 illustrates an example embodiment where the operation 208 of example operational flow 200 of FIG. 2 may include at least one additional operation. Additional operations may include an operation 1302, 1304, or 1306.

Operation 1302 illustrates generating at least one of a verbal response, a visual response, or a control instruction. Upon identification of one or more commands associated with the system vocabulary 114, the command module 160 may generate a command response based on the one or more commands. The command response may be of any type known in the art such as, but not limited to, a verbal response (e.g. a simulated voice providing a spoken response, playback of a recording, and the like), a visual response (e.g. an indicator light, a message on a display, and the like) or one or more control instructions to one or more connected devices 102 (e.g. powering off a device, turning on a television, adjusting the volume of an audio system, and the like).

Operation 1304 illustrates identifying one or more target devices for the one or more responses. Operation 1306 illustrates identifying one or more target devices for the one or more responses, wherein the target device is different than an input device receiving the one or more signals. For example, the command recognition controller 104 may transmit the command response via the controller network module 156 over the network 106 to one or more target connected devices 102. In this regard, any of the connected devices 102 may receive a command response based on a command received by any of the other connected devices 102 (e.g. a user 116 may provide command signals 120 to a television to power on a luminaire).

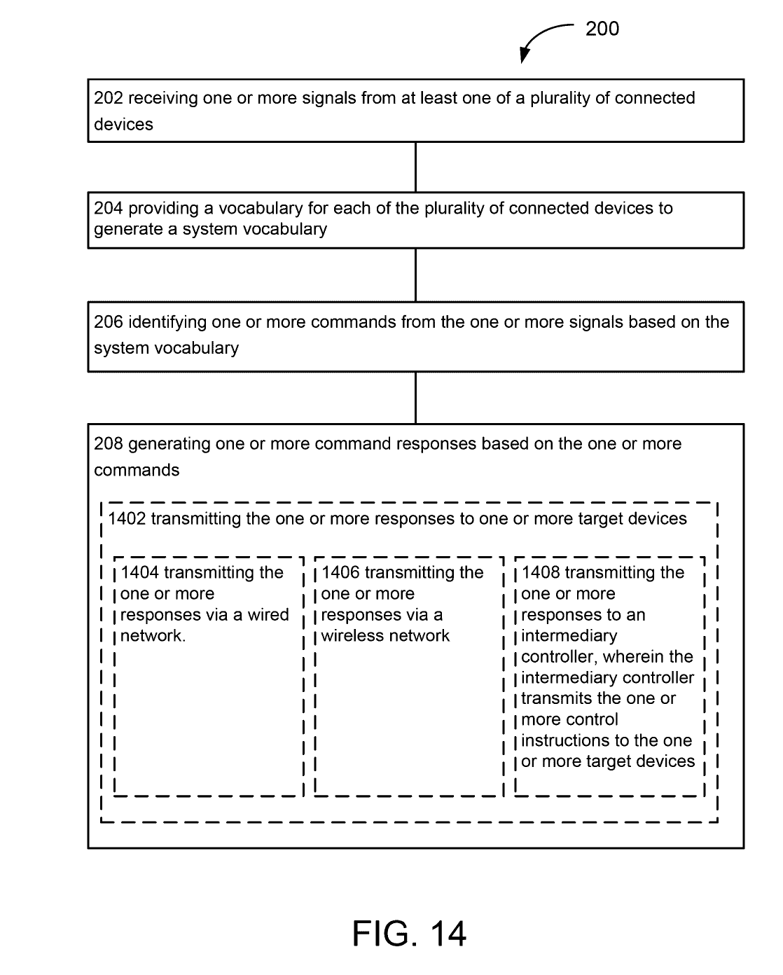

FIG. 14 illustrates an example embodiment where the operation 208 of example operational flow 200 of FIG. 2 may include at least one additional operation. Additional operations may include an operation 1402, 1404, or 1406.

Operation 1402 illustrates transmitting the one or more command responses to one or more target devices. For example, a command module 160 may transmit one or more command responses to one or more target connected devices 102 via the network 106 (e.g. using the controller network module 156). In this regard the controller network module 156 may translate the one or more command responses according to a defined protocol for the network 106 so as to enable transmission of the one or more command responses to the one or more target connected devices 102. Further, the device network module 152 of the target connected devices 102 may translate the signal transmitted over the network 106 back to a native data format (e.g. a control instruction or a direction to provide a notification (e.g. a verbal notification or a visual notification) to a user 116).

Operation 1404 illustrates transmitting the one or more responses via a wired network. Operation 1406 illustrates transmitting the one or more command responses via a wireless network. For example, any network modules (the controller network module 156, the device network module 152, and the like) may include, but is not limited to, a wired network adapter (e.g. an Ethernet adapter, a powerline adapter, and the like), a wireless network adapter and associated antenna (e.g. a Wi-Fi network adapter, a Bluetooth network adapter, and the like), or a cellular network adapter. Operation 1408 illustrates transmitting the one or more responses to an intermediary controller, wherein the intermediary controller transmits the one or more control instructions to the one or more target devices. It may be the case that an intermediary recognition controller 108 may operate as a communication bridge between the command recognition controller 104 and one or more connected devices 102. In this regard, an intermediary recognition controller 108 may function as a hub for a family of connected devices 102 (e.g. connected devices 102 associated with a specific brand or connected devices 102 utilizing a common network protocol).

In one exemplary embodiment, a connected device network 100 may include a set of connected devices 102 (e.g. light switches) that communicate across the network 106 via a mesh BLE protocol, a set of connected devices 102 (e.g. a thermostat and one or more connected appliances) that communicate across the network 106 via a Wi-Fi protocol, a set of connected devices 102 (e.g. media equipment) that communicate across the network 106 via a wired Ethernet protocol, a set of connected devices 102 (e.g. sensors) that communicate to an intermediary recognition controller 108 (e.g. a hub) via a proprietary wireless protocol, which further communicates across the network 106 via a wired Ethernet protocol, and a set of connected devices 102 (e.g. mobile devices) that communicate across the network 106 via a cellular network protocol.

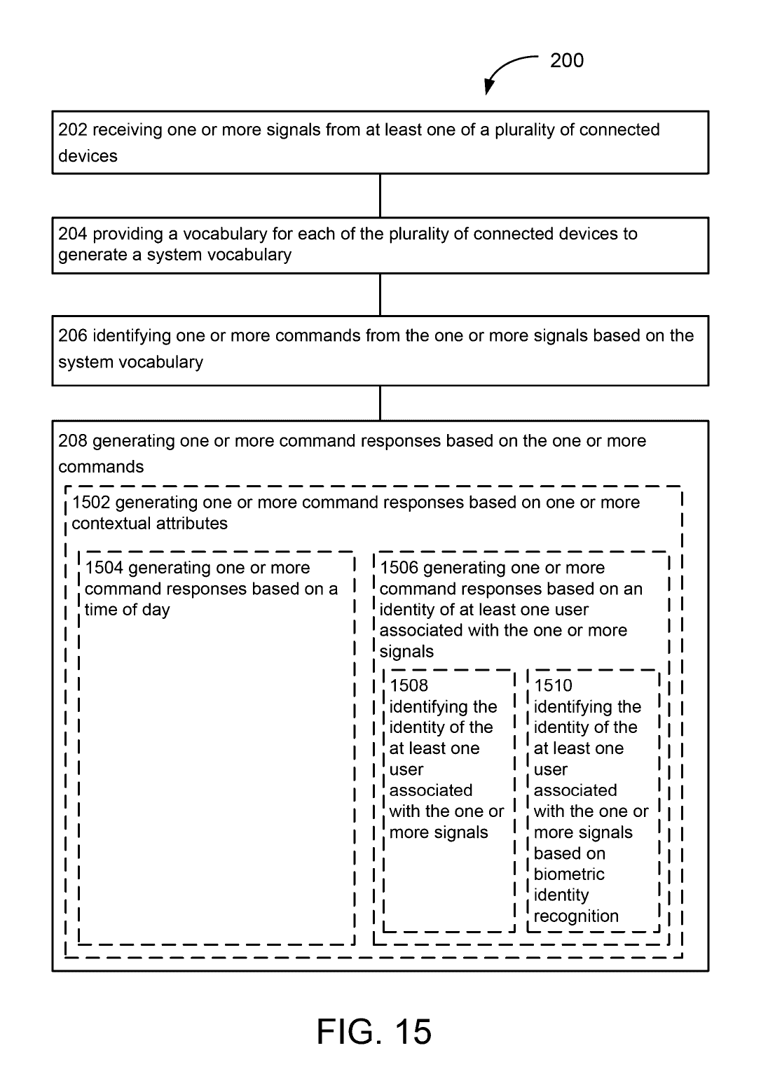

FIG. 15 illustrates an example embodiment where the operation 208 of example operational flow 200 of FIG. 2 may include at least one additional operation. Additional operations may include an operation 1502, 1504, or 1506, 1508, or 1510.

Operation 1502 illustrates generating one or more command responses based on one or more contextual attributes. In some exemplary embodiments, the command recognition controller 104 generates a command response based on contextual attributes. The contextual attributes may be associated with any of, but are not limited to, ambient conditions, a user 116, or the connected devices 102. Further, the contextual attributes may be determined by the command recognition controller 104 (e.g. the number and type of connected devices 102), or by a sensor 128 (e.g. a light sensor, a motion sensor, an occupancy sensor, or the like) associated with at least one of the connected devices 102. Further, the command recognition controller 104 may respond to contextual attributes through internal logic (e.g. one or more rules) or query an external source (e.g. a remote host).

Operation 1504 illustrates generating one or more command responses based on a time of day. For example, in response to a user 116 leaving a room at noon and providing command signals 120 including “turn off”, the command recognition controller 104 may generate control instructions directed to connected devices 102 connected to luminaires to turn off the lights. Alternatively, in response to a user 116 leaving a room at midnight and providing command signals 120 including “turn off”, the command recognition controller 104 may generate control instructions directed to all proximate connected devices 102 to turn off connected devices 102 not required in an empty room (e.g. a television, an audio system, a ceiling fan, and the like).

Operation 1506 illustrates generating one or more command responses based on an identity of at least one user associated with the one or more signals. Further, operations 1508 and 1510 illustrate identifying the identity of the at least one user associated with the one or more signals and identifying the identity of the at least one user associated with the one or more signals based on biometric identity recognition. For example, the command recognition controller 104 may generate a command response based on the identities of a user 116. The identity of a user 116 may be determined by any technique known in the art including, but not limited to, verbal authentication, voice recognition (e.g. provided by the command recognition controller 104 or an external system), biometric identity recognition (e.g. facial recognition provided by a sensor 128), the presence of an identifying tag (e.g. a Bluetooth or RFID device designating the identity of the user 116), or the like. In this regard, the command recognition controller 104 may generate a different command response upon identification of a command (e.g. by the command module 160) based on the identity of the user 116. For example, the command recognition controller 104, in response to command signals 120 including “watch the news,” may generate control instructions to a television operating as one of the connected devices 102 to turn on different channels based upon the identity of the user 116.

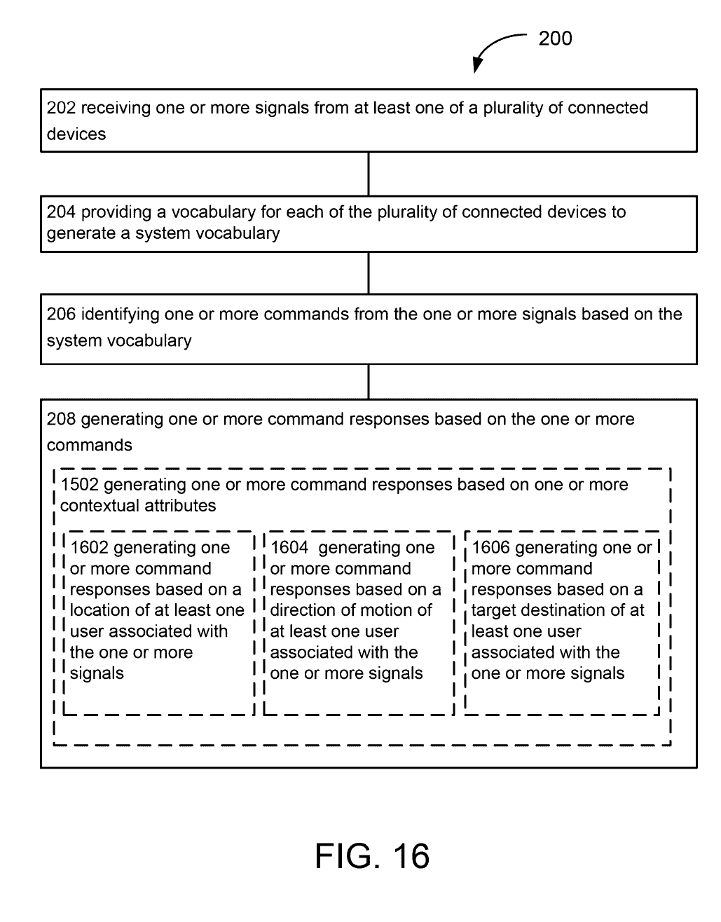

FIG. 16 illustrates an example embodiment where the operation 1502 of example operational flow 1500 of FIG. 15 may include at least one additional operation. Additional operations may include an operation 1602, 1604, or 1606.

Operation 1602 illustrates generating one or more command responses based on a location of at least one user associated with the one or more signals. Further, operations 1604 and 1606 illustrate generating one or more command responses based on a direction of motion of at least one user associated with the one or more signals and generating one or more command responses based on a target destination of at least one user associated with the one or more signals. For example, the command recognition controller 104 may generate a command response based on the location-based contextual attributes of a user 116 such as, but not limited to, location (e.g. a GPS location, a location within a building, a location within a room, and the like), direction of motion (e.g. as determined by GPS, direction along a route, direction of motion within a building, direction of motion within a room, and the like), intended destination (e.g. associated with a route stored in a GPS device connected to the connected device network 100, a destination associated with a calendar appointment, and the like).

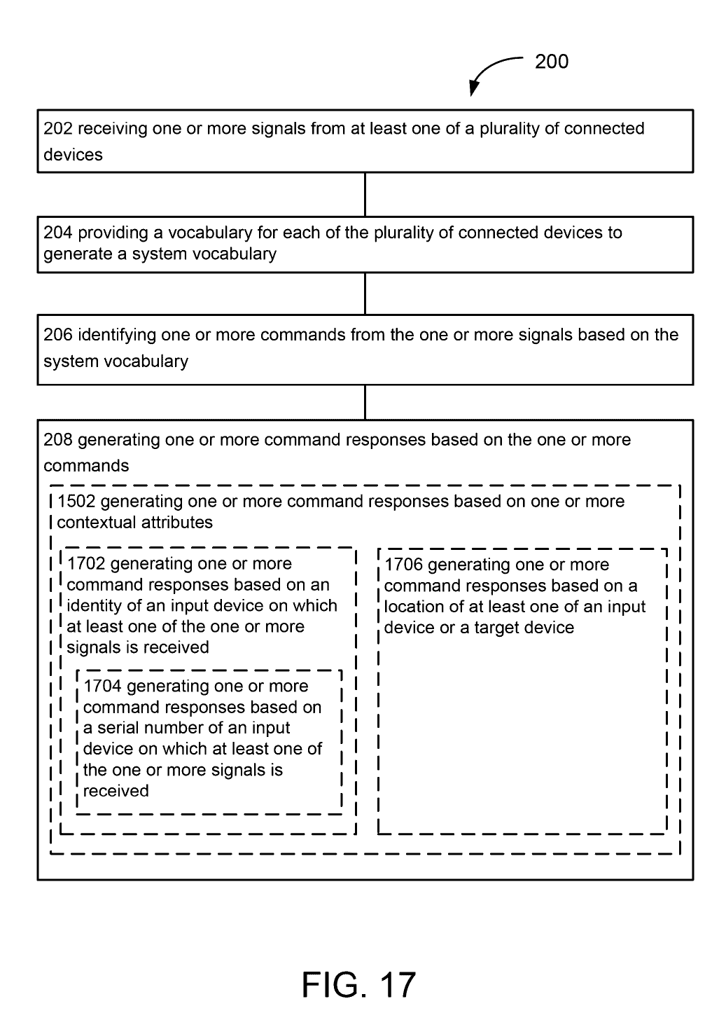

FIG. 17 illustrates an example embodiment where the operation 1502 of example operational flow 1500 of FIG. 15 may include at least one additional operation. Additional operations may include an operation 1702, 1704, or 1706.

Operation 1702 illustrates generating one or more command responses based on an identity of an input device on which at least one of the one or more signals is received. Further, operation 1704 illustrates generating one or more command responses based on a serial number of an input device on which at least one of the one or more signals is received. Operation 1706 illustrates generating one or more command responses based on a location of at least one of an input device or a target device. For example, the command recognition controller 104 may generate a command response based on the locations of connected devices 102 that receive the command signals 120. In this regard, the command recognition controller 104 may only generate a command response directed to luminaires within a specific room in response to command signals 120 received by connected devices 102 within the same room unless the command signals 120 includes explicit commands to the contrary. Additionally, it may be the case that certain connected devices 102 are unaware of their respective locations, but the command recognition controller 104 may be aware of their locations (e.g. as provided by a user 116).

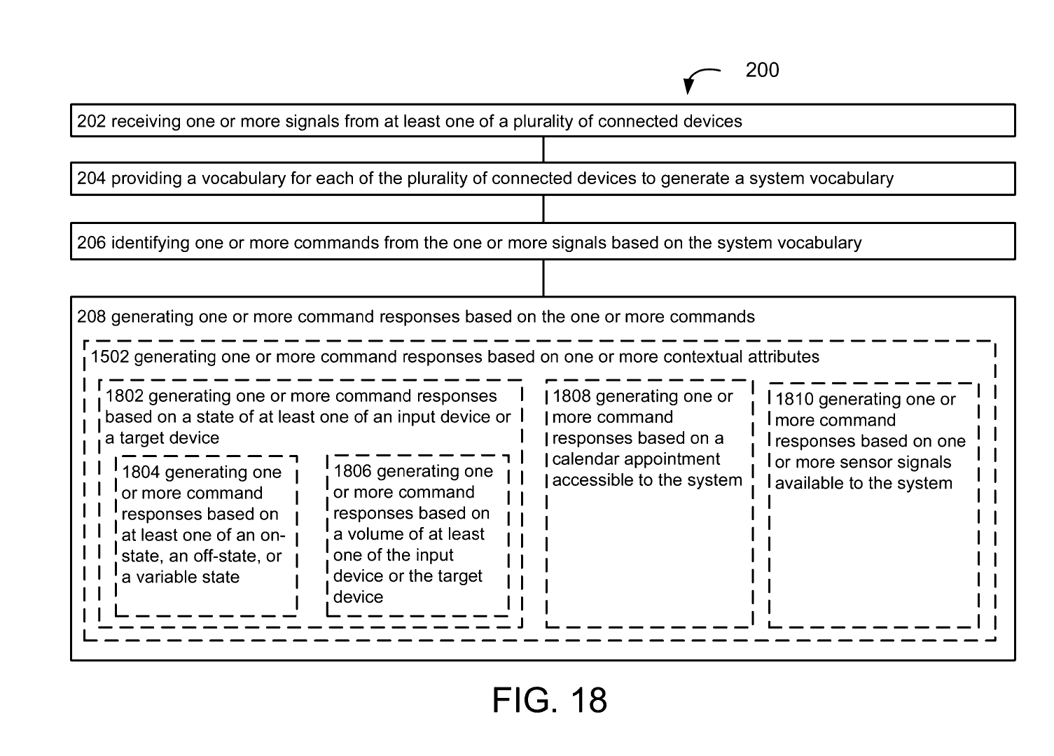

FIG. 18 illustrates an example embodiment where the operation 1502 of example operational flow 1500 of FIG. 15 may include at least one additional operation. Additional operations may include an operation 1802, 1804, 1806, 1808, or 1810.

Operation 1802 illustrates generating one or more command responses based on a state of at least one of an input device or a target device. Further, operations 1804 and 1806 illustrate generating one or more command responses based on at least one of an on-state, an off-state, or a variable state and generating one or more command responses based on a volume of at least one of the input device or the target device. For example, the command recognition controller 104 may generate a command response based on a state of one or more target connected devices 102. In this regard, a command response may be to toggle a state (e.g. powered on/powered off) of connected devices 102. Additionally, a command response may be based on a continuous state (e.g. the volume of an audio device or the set temperature of a thermostat). In this regard, in response to command signals 120 including “turn up the radio,” the command recognition controller 104 may generate command instructions to increase the volume of a radio operating as one of the connected devices 102 beyond a current set point.

Operation 1808 illustrates generating one or more command responses based on a calendar appointment accessible to the system. For example, a command module 160 of a command recognition controller 104 may generate one or more command responses based on a calendar appointment (e.g. a scheduled meeting, a scheduled event, a holiday, or the like). A calendar appointment may be associated with a calendar stored locally (e.g. on the local area network) or a remotely-hosted calendar (e.g. on Google Calendar, iCloud, and the like).

Operation 1810 illustrates generating one or more command responses based on one or more sensor signals available to the system. For example, connected devices 102 may include one or more sensors (a motion sensor, an occupancy sensor, a door/window sensor, a thermometer, a humidity sensor, a light sensor, and the like). Further, a command module 160 of a command recognition controller 104 may generate one or more command responses based on one or more output of the one or more sensors. For example, upon receiving command signals 120 including “turn off the lights,” a command module 160 may first determine one or more occupied rooms (e.g. via one or more occupancy sensors) and generate one or more command responses to power off luminaires only in unoccupied rooms.

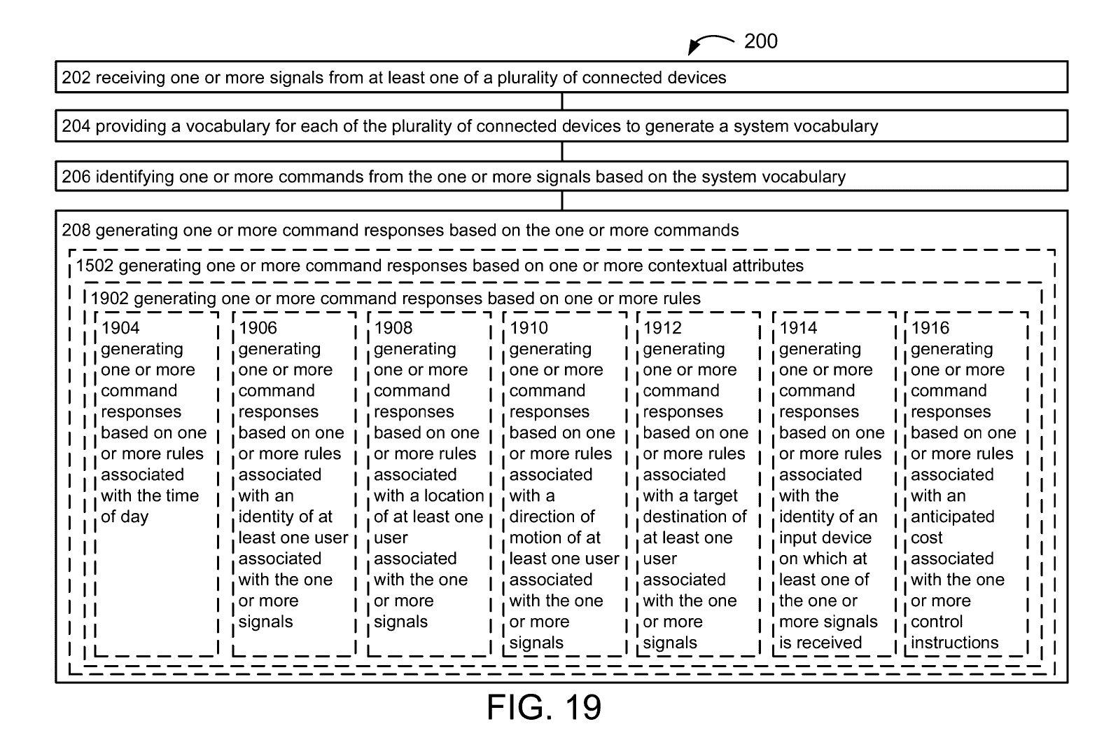

FIG. 19 illustrates an example embodiment where the operation 1502 of example operational flow 1500 of FIG. 15 may include at least one additional operation. Additional operations may include an operation 1902, 1904, 1906, 1908, 1910, 1912, 1914, or 1916.

Operation 1902 illustrates generating one or more command responses based on one or more rules. Further, operations 1904, and 1906, 1908, 1910, 1912, 1914, and 1916 illustrate generating one or more command responses based on one or more rules associated with the time of day (e.g. during the day or during the night), generating one or more command responses based on one or more rules associated with an identity of at least one user associated with the one or more signals (e.g. a parent, a child, an identified user 116, and the like). For example, the command recognition controller 104 generates a command response based on one or more rules that may override command signals 120. In this regard, the command recognition controller 104 may include a rule that a select user 116 (e.g. a child) may not operate selected connected devices 102 (e.g. a television) during a certain timeframe. Accordingly, the command recognition controller 104 may selectively ignore command signals 120 associated with the select user 116 during the designated timeframe. Further, the command recognition controller 104 may include mechanisms to override the rules. Continuing the above example, the select user 116 (e.g. the child) may request authorization from an additional user 116 (e.g. a parent).

Operations 1908, 1910, and 1912 illustrate generating one or more command responses based on one or more rules associated with a location of at least one user associated with the one or more signals (e.g. the location of a user 116 in a room, within a building, a GPS-identified location, and the like), generating one or more command responses based on one or more rules associated with a direction of motion of at least one user associated with the one or more signals (e.g. as determined by GPS, direction along a route, direction of motion within a building, direction of motion within a room, and the like), generating one or more command responses based on one or more rules associated with a target destination of at least one user associated with the one or more signals (e.g. associated with a route stored in a GPS device connected to the connected device network 100, a target destination associated with a calendar appointment, and the like).

Operation 1914 illustrates generating one or more command responses based on one or more rules associated with the identity of an input device on which at least one of the one or more signals is received (e.g. serial numbers, model numbers, and the like of connected devices 102).

Operation 1916 illustrates generating one or more command responses based on one or more rules associated with an anticipated cost associated with the one or more control instructions.

As an additional example, the command recognition controller 104 may include rules associated with cost. In this regard, connected devices 102 may analyze the cost associated with a command and selectively ignore the command or request authorization to perform the command. For example, the command recognition controller 104 may have a rule designating that selected connected devices 102 may utilize resources (e.g. energy, money, or the like) up to a determined threshold.

The present application uses formal outline headings for clarity of presentation. However, it is to be understood that the outline headings are for presentation purposes, and that different types of subject matter may be discussed throughout the application (e.g., device(s)/structure(s) may be described under process(es)/operations heading(s) and/or process(es)/operations may be discussed under structure(s)/process(es) headings; and/or descriptions of single topics may span two or more topic headings). Hence, the use of the formal outline headings is not intended to be in any way limiting.

Throughout this application, examples and lists are given, with parentheses, the abbreviation “e.g.,” or both. Unless explicitly otherwise stated, these examples and lists are merely exemplary and are non-exhaustive. In most cases, it would be prohibitive to list every example and every combination. Thus, smaller, illustrative lists and examples are used, with focus on imparting understanding of the claim terms rather than limiting the scope of such terms.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting.

Although user 105 is shown/described herein as a single illustrated figure, those skilled in the art will appreciate that user 105 may be representative of a human user, a robotic user (e.g., computational entity), and/or substantially any combination thereof (e.g., a user may be assisted by one or more robotic agents) unless context dictates otherwise. Those skilled in the art will appreciate that, in general, the same may be said of “sender” and/or other entity-oriented terms as such terms are used herein unless context dictates otherwise.

Those having skill in the art will recognize that the state of the art has progressed to the point where there is little distinction left between hardware, software, and/or firmware implementations of aspects of systems; the use of hardware, software, and/or firmware is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware in one or more machines, compositions of matter, and articles of manufacture, limited to patentable subject matter under 35 USC 101. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

In some implementations described herein, logic and similar implementations may include software or other control structures. Electronic circuitry, for example, may have one or more paths of electrical current constructed and arranged to implement various functions as described herein. In some implementations, one or more media may be configured to bear a device-detectable implementation when such media hold or transmit device detectable instructions operable to perform as described herein. In some variants, for example, implementations may include an update or modification of existing software or firmware, or of gate arrays or programmable hardware, such as by performing a reception of or a transmission of one or more instructions in relation to one or more operations described herein. Alternatively or additionally, in some variants, an implementation may include special-purpose hardware, software, firmware components, and/or general-purpose components executing or otherwise invoking special-purpose components. Specifications or other implementations may be transmitted by one or more instances of tangible transmission media as described herein, optionally by packet transmission or otherwise by passing through distributed media at various times.

Alternatively or additionally, implementations may include executing a special-purpose instruction sequence or invoking circuitry for enabling, triggering, coordinating, requesting, or otherwise causing one or more occurrences of virtually any functional operations described herein. In some variants, operational or other logical descriptions herein may be expressed as source code and compiled or otherwise invoked as an executable instruction sequence. In some contexts, for example, implementations may be provided, in whole or in part, by source code, such as C++, or other code sequences. In other implementations, source or other code implementation, using commercially available and/or techniques in the art, may be compiled//implemented/translated/converted into a high-level descriptor language (e.g., initially implementing described technologies in C or C++ programming language and thereafter converting the programming language implementation into a logic-synthesizable language implementation, a hardware description language implementation, a hardware design simulation implementation, and/or other such similar mode(s) of expression). For example, some or all of a logical expression (e.g., computer programming language implementation) may be manifested as a Verilog-type hardware description (e.g., via Hardware Description Language (HDL) and/or Very High Speed Integrated Circuit Hardware Descriptor Language (VHDL)) or other circuitry model which may then be used to create a physical implementation having hardware (e.g., an Application Specific Integrated Circuit). Those skilled in the art will recognize how to obtain, configure, and optimize suitable transmission or computational elements, material supplies, actuators, or other structures in light of these teachings.

The claims, description, and drawings of this application may describe one or more of the instant technologies in operational/functional language, for example as a set of operations to be performed by a computer. Such operational/functional description in most instances would be understood by one skilled the art as specifically-configured hardware (e.g., because a general purpose computer in effect becomes a special purpose computer once it is programmed to perform particular functions pursuant to instructions from program software).

Importantly, although the operational/functional descriptions described herein are understandable by the human mind, they are not abstract ideas of the operations/functions divorced from computational implementation of those operations/functions. Rather, the operations/functions represent a specification for the massively complex computational machines or other means. As discussed in detail below, the operational/functional language must be read in its proper technological context, i.e., as concrete specifications for physical implementations.

The logical operations/functions described herein are a distillation of machine specifications or other physical mechanisms specified by the operations/functions such that the otherwise inscrutable machine specifications may be comprehensible to the human mind. The distillation also allows one of skill in the art to adapt the operational/functional description of the technology across many different specific vendors' hardware configurations or platforms, without being limited to specific vendors' hardware configurations or platforms.

Some of the present technical description (e.g., detailed description, drawings, claims, etc.) may be set forth in terms of logical operations/functions. As described in more detail in the following paragraphs, these logical operations/functions are not representations of abstract ideas, but rather representative of static or sequenced specifications of various hardware elements. Differently stated, unless context dictates otherwise, the logical operations/functions will be understood by those of skill in the art to be representative of static or sequenced specifications of various hardware elements. This is true because tools available to one of skill in the art to implement technical disclosures set forth in operational/functional formats—tools in the form of a high-level programming language (e.g., C, java, visual basic), etc.), or tools in the form of Very high speed Hardware Description Language (“VHDL,” which is a language that uses text to describe logic circuits)—are generators of static or sequenced specifications of various hardware configurations. This fact is sometimes obscured by the broad term “software,” but, as shown by the following explanation, those skilled in the art understand that what is termed “software” is shorthand for a massively complex interchaining/specification of ordered-matter elements. The term “ordered-matter elements” may refer to physical components of computation, such as assemblies of electronic logic gates, molecular computing logic constituents, quantum computing mechanisms, etc.

For example, a high-level programming language is a programming language with strong abstraction, e.g., multiple levels of abstraction, from the details of the sequential organizations, states, inputs, outputs, etc., of the machines that a high-level programming language actually specifies. See, e.g., Wikipedia, High-level programming language, http://en.wikipedia.org/wiki/High-level_programming_language (as of Jun. 5, 2012, 21:00 GMT). In order to facilitate human comprehension, in many instances, high-level programming languages resemble or even share symbols with natural languages. See, e.g., Wikipedia, Natural language, http://en.wikipedia.org/wiki/Natural_language (as of Jun. 5, 2012, 21:00 GMT).

It has been argued that because high-level programming languages use strong abstraction (e.g., that they may resemble or share symbols with natural languages), they are therefore a “purely mental construct.” (e.g., that “software”—a computer program or computer programming—is somehow an ineffable mental construct, because at a high level of abstraction, it can be conceived and understood in the human mind). This argument has been used to characterize technical description in the form of functions/operations as somehow “abstract ideas.” In fact, in technological arts (e.g., the information and communication technologies) this is not true.

The fact that high-level programming languages use strong abstraction to facilitate human understanding should not be taken as an indication that what is expressed is an abstract idea. In fact, those skilled in the art understand that just the opposite is true. If a high-level programming language is the tool used to implement a technical disclosure in the form of functions/operations, those skilled in the art will recognize that, far from being abstract, imprecise, “fuzzy,” or “mental” in any significant semantic sense, such a tool is instead a near incomprehensibly precise sequential specification of specific computational machines—the parts of which are built up by activating/selecting such parts from typically more general computational machines over time (e.g., clocked time). This fact is sometimes obscured by the superficial similarities between high-level programming languages and natural languages. These superficial similarities also may cause a glossing over of the fact that high-level programming language implementations ultimately perform valuable work by creating/controlling many different computational machines.

The many different computational machines that a high-level programming language specifies are almost unimaginably complex. At base, the hardware used in the computational machines typically consists of some type of ordered matter (e.g., traditional electronic devices (e.g., transistors), deoxyribonucleic acid (DNA), quantum devices, mechanical switches, optics, fluidics, pneumatics, optical devices (e.g., optical interference devices), molecules, etc.) that are arranged to form logic gates. Logic gates are typically physical devices that may be electrically, mechanically, chemically, or otherwise driven to change physical state in order to create a physical reality of Boolean logic.

Logic gates may be arranged to form logic circuits, which are typically physical devices that may be electrically, mechanically, chemically, or otherwise driven to create a physical reality of certain logical functions. Types of logic circuits include such devices as multiplexers, registers, arithmetic logic units (ALUs), computer memory, etc., each type of which may be combined to form yet other types of physical devices, such as a central processing unit (CPU)—the best known of which is the microprocessor. A modern microprocessor will often contain more than one hundred million logic gates in its many logic circuits (and often more than a billion transistors). See, e.g., Wikipedia, Logic gates, http://en.wikipedia.org/wiki/Logic_gates (as of Jun. 5, 2012, 21:03 GMT).

The logic circuits forming the microprocessor are arranged to provide a microarchitecture that will carry out the instructions defined by that microprocessor's defined Instruction Set Architecture. The Instruction Set Architecture is the part of the microprocessor architecture related to programming, including the native data types, instructions, registers, addressing modes, memory architecture, interrupt and exception handling, and external Input/Output. See, e.g., Wikipedia, Computer architecture, http://en.wikipedia.org/wiki/Computer_architecture (as of Jun. 5, 2012, 21:03 GMT).

The Instruction Set Architecture includes a specification of the machine language that can be used by programmers to use/control the microprocessor. Since the machine language instructions are such that they may be executed directly by the microprocessor, typically they consist of strings of binary digits, or bits. For example, a typical machine language instruction might be many bits long (e.g., 32, 64, or 128 bit strings are currently common). A typical machine language instruction might take the form “11110000101011110000111100111111” (a 32 bit instruction).

It is significant here that, although the machine language instructions are written as sequences of binary digits, in actuality those binary digits specify physical reality. For example, if certain semiconductors are used to make the operations of Boolean logic a physical reality, the apparently mathematical bits “1” and “0” in a machine language instruction actually constitute shorthand that specifies the application of specific voltages to specific wires. For example, in some semiconductor technologies, the binary number “1” (e.g., logical “1”) in a machine language instruction specifies around +5 volts applied to a specific “wire” (e.g., metallic traces on a printed circuit board) and the binary number “0” (e.g., logical “0”) in a machine language instruction specifies around −5 volts applied to a specific “wire.” In addition to specifying voltages of the machines' configuration, such machine language instructions also select out and activate specific groupings of logic gates from the millions of logic gates of the more general machine. Thus, far from abstract mathematical expressions, machine language instruction programs, even though written as a string of zeros and ones, specify many, many constructed physical machines or physical machine states.

Machine language is typically incomprehensible by most humans (e.g., the above example was just ONE instruction, and some personal computers execute more than two billion instructions every second). See, e.g., Wikipedia, Instructions per second, http://en.wikipedia.org/wiki/Instructions_per_second (as of Jun. 5, 2012, 21:04 GMT). Thus, programs written in machine language—which may be tens of millions of machine language instructions long—are incomprehensible. In view of this, early assembly languages were developed that used mnemonic codes to refer to machine language instructions, rather than using the machine language instructions' numeric values directly (e.g., for performing a multiplication operation, programmers coded the abbreviation “mutt,” which represents the binary number “011000” in MIPS machine code). While assembly languages were initially a great aid to humans controlling the microprocessors to perform work, in time the complexity of the work that needed to be done by the humans outstripped the ability of humans to control the microprocessors using merely assembly languages.

At this point, it was noted that the same tasks needed to be done over and over, and the machine language necessary to do those repetitive tasks was the same. In view of this, compilers were created. A compiler is a device that takes a statement that is more comprehensible to a human than either machine or assembly language, such as “add 2+2 and output the result,” and translates that human understandable statement into a complicated, tedious, and immense machine language code (e.g., millions of 32, 64, or 128 bit length strings). Compilers thus translate high-level programming language into machine language.

This compiled machine language, as described above, is then used as the technical specification which sequentially constructs and causes the interoperation of many different computational machines such that humanly useful, tangible, and concrete work is done. For example, as indicated above, such machine language—the compiled version of the higher-level language—functions as a technical specification which selects out hardware logic gates, specifies voltage levels, voltage transition timings, etc., such that the humanly useful work is accomplished by the hardware.

Thus, a functional/operational technical description, when viewed by one of skill in the art, is far from an abstract idea. Rather, such a functional/operational technical description, when understood through the tools available in the art such as those just described, is instead understood to be a humanly understandable representation of a hardware specification, the complexity and specificity of which far exceeds the comprehension of most any one human. With this in mind, those skilled in the art will understand that any such operational/functional technical descriptions—in view of the disclosures herein and the knowledge of those skilled in the art—may be understood as operations made into physical reality by (a) one or more interchained physical machines, (b) interchained logic gates configured to create one or more physical machine(s) representative of sequential/combinatorial logic(s), (c) interchained ordered matter making up logic gates (e.g., interchained electronic devices (e.g., transistors), DNA, quantum devices, mechanical switches, optics, fluidics, pneumatics, molecules, etc.) that create physical reality representative of logic(s), or (d) virtually any combination of the foregoing. Indeed, any physical object which has a stable, measurable, and changeable state may be used to construct a machine based on the above technical description. Charles Babbage, for example, constructed the first computer out of wood and powered by cranking a handle.

Thus, far from being understood as an abstract idea, those skilled in the art will recognize a functional/operational technical description as a humanly-understandable representation of one or more almost unimaginably complex and time sequenced hardware instantiations. The fact that functional/operational technical descriptions might lend themselves readily to high-level computing languages (or high-level block diagrams for that matter) that share some words, structures, phrases, etc. with natural language simply cannot be taken as an indication that such functional/operational technical descriptions are abstract ideas, or mere expressions of abstract ideas. In fact, as outlined herein, in the technological arts this is simply not true. When viewed through the tools available to those of skill in the art, such functional/operational technical descriptions are seen as specifying hardware configurations of almost unimaginable complexity.

As outlined above, the reason for the use of functional/operational technical descriptions is at least twofold. First, the use of functional/operational technical descriptions allows near-infinitely complex machines and machine operations arising from interchained hardware elements to be described in a manner that the human mind can process (e.g., by mimicking natural language and logical narrative flow). Second, the use of functional/operational technical descriptions assists the person of skill in the art in understanding the described subject matter by providing a description that is more or less independent of any specific vendor's piece(s) of hardware.

The use of functional/operational technical descriptions assists the person of skill in the art in understanding the described subject matter since, as is evident from the above discussion, one could easily, although not quickly, transcribe the technical descriptions set forth in this document as trillions of ones and zeroes, billions of single lines of assembly-level machine code, millions of logic gates, thousands of gate arrays, or any number of intermediate levels of abstractions. However, if any such low-level technical descriptions were to replace the present technical description, a person of skill in the art could encounter undue difficulty in implementing the disclosure, because such a low-level technical description would likely add complexity without a corresponding benefit (e.g., by describing the subject matter utilizing the conventions of one or more vendor-specific pieces of hardware). Thus, the use of functional/operational technical descriptions assists those of skill in the art by separating the technical descriptions from the conventions of any vendor-specific piece of hardware.

In view of the foregoing, the logical operations/functions set forth in the present technical description are representative of static or sequenced specifications of various ordered-matter elements, in order that such specifications may be comprehensible to the human mind and adaptable to create many various hardware configurations. The logical operations/functions disclosed herein should be treated as such, and should not be disparagingly characterized as abstract ideas merely because the specifications they represent are presented in a manner that one of skill in the art can readily understand and apply in a manner independent of a specific vendor's hardware implementation.

Those skilled in the art will recognize that it is common within the art to implement devices and/or processes and/or systems, and thereafter use engineering and/or other practices to integrate such implemented devices and/or processes and/or systems into more comprehensive devices and/or processes and/or systems. That is, at least a portion of the devices and/or processes and/or systems described herein can be integrated into other devices and/or processes and/or systems via a reasonable amount of experimentation. Those having skill in the art will recognize that examples of such other devices and/or processes and/or systems might include—as appropriate to context and application—all or part of devices and/or processes and/or systems of (a) an air conveyance (e.g., an airplane, rocket, helicopter, etc.), (b) a ground conveyance (e.g., a car, truck, locomotive, tank, armored personnel carrier, etc.), (c) a building (e.g., a home, warehouse, office, etc.), (d) an appliance (e.g., a refrigerator, a washing machine, a dryer, etc.), (e) a communications system (e.g., a networked system, a telephone system, a Voice over IP system, etc.), (f) a business entity (e.g., an Internet Service Provider (ISP) entity such as Comcast Cable, Qwest, Southwestern Bell, etc.), or (g) a wired/wireless services entity (e.g., Sprint, Cingular, Nextel, etc.), etc.

In certain cases, use of a system or method may occur in a territory even if components are located outside the territory. For example, in a distributed computing context, use of a distributed computing system may occur in a territory even though parts of the system may be located outside of the territory (e.g., relay, server, processor, signal-bearing medium, transmitting computer, receiving computer, etc. located outside the territory).

A sale of a system or method may likewise occur in a territory even if components of the system or method are located and/or used outside the territory. Further, implementation of at least part of a system for performing a method in one territory does not preclude use of the system in another territory

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (e.g. “configured to”) generally encompass active-state components and/or inactive-state components and/or standby-state components, unless context requires otherwise.

In a general sense, those skilled in the art will recognize that the various embodiments described herein can be implemented, individually and/or collectively, by various types of electro-mechanical systems having a wide range of electrical components such as hardware, software, firmware, and/or virtually any combination thereof, limited to patentable subject matter under 35 U.S.C. 101; and a wide range of components that may impart mechanical force or motion such as rigid bodies, spring or torsional bodies, hydraulics, electro-magnetically actuated devices, and/or virtually any combination thereof. Consequently, as used herein “electro-mechanical system” includes, but is not limited to, electrical circuitry operably coupled with a transducer (e.g., an actuator, a motor, a piezoelectric crystal, a Micro Electro Mechanical System (MEMS), etc.), electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), electrical circuitry forming a communications device (e.g., a modem, communications switch, optical-electrical equipment, etc.), and/or any non-electrical analog thereto, such as optical or other analogs (e.g., graphene based circuitry). Those skilled in the art will also appreciate that examples of electro-mechanical systems include but are not limited to a variety of consumer electronics systems, medical devices, as well as other systems such as motorized transport systems, factory automation systems, security systems, and/or communication/computing systems. Those skilled in the art will recognize that electro-mechanical as used herein is not necessarily limited to a system that has both electrical and mechanical actuation except as context may dictate otherwise.

In a general sense, those skilled in the art will recognize that the various aspects described herein which can be implemented, individually and/or collectively, by a wide range of hardware, software, firmware, and/or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), and/or electrical circuitry forming a communications device (e.g., a modem, communications switch, optical-electrical equipment, etc.). Those having skill in the art will recognize that the subject matter described herein may be implemented in an analog or digital fashion or some combination thereof.

Those skilled in the art will recognize that at least a portion of the devices and/or processes described herein can be integrated into a data processing system. Those having skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems.

For the purposes of this application, “cloud” computing may be understood as described in the cloud computing literature. For example, cloud computing may be methods and/or systems for the delivery of computational capacity and/or storage capacity as a service. The “cloud” may refer to one or more hardware and/or software components that deliver or assist in the delivery of computational and/or storage capacity, including, but not limited to, one or more of a client, an application, a platform, an infrastructure, and/or a server The cloud may refer to any of the hardware and/or software associated with a client, an application, a platform, an infrastructure, and/or a server. For example, cloud and cloud computing may refer to one or more of a computer, a processor, a storage medium, a router, a switch, a modem, a virtual machine (e.g., a virtual server), a data center, an operating system, a middleware, a firmware, a hardware back-end, a software back-end, and/or a software application. A cloud may refer to a private cloud, a public cloud, a hybrid cloud, and/or a community cloud. A cloud may be a shared pool of configurable computing resources, which may be public, private, semi-private, distributable, scaleable, flexible, temporary, virtual, and/or physical. A cloud or cloud service may be delivered over one or more types of network, e.g., a mobile communication network, and the Internet.

As used in this application, a cloud or a cloud service may include one or more of infrastructure-as-a-service (“IaaS”), platform-as-a-service (“PaaS”), software-as-a-service (“SaaS”), and/or desktop-as-a-service (“DaaS”). As a non-exclusive example, IaaS may include, e.g., one or more virtual server instantiations that may start, stop, access, and/or configure virtual servers and/or storage centers (e.g., providing one or more processors, storage space, and/or network resources on-demand, e.g., EMC and Rackspace). PaaS may include, e.g., one or more software and/or development tools hosted on an infrastructure (e.g., a computing platform and/or a solution stack from which the client can create software interfaces and applications, e.g., Microsoft Azure). SaaS may include, e.g., software hosted by a service provider and accessible over a network (e.g., the software for the application and/or the data associated with that software application may be kept on the network, e.g., Google Apps, SalesForce). DaaS may include, e.g., providing desktop, applications, data, and/or services for the user over a network (e.g., providing a multi-application framework, the applications in the framework, the data associated with the applications, and/or services related to the applications and/or the data over the network, e.g., Citrix). The foregoing is intended to be exemplary of the types of systems and/or methods referred to in this application as “cloud” or “cloud computing” and should not be considered complete or exhaustive.

The proliferation of automation in many transactions is apparent. For example, Automated Teller Machines (“ATMs”) dispense money and receive deposits. Airline ticket counter machines check passengers in, dispense tickets, and allow passengers to change or upgrade flights. Train and subway ticket counter machines allow passengers to purchase a ticket to a particular destination without invoking a human interaction at all. Many groceries and pharmacies have self-service checkout machines which allow a consumer to pay for goods purchased by interacting only with a machine. Large companies now staff telephone answering systems with machines that interact with customers, and invoke a human in the transaction only if there is a problem with the machine-facilitated transaction.

Nevertheless, as such automation increases, convenience and accessibility may decrease. Self-checkout machines at grocery stores may be difficult to operate. ATMs and ticket counter machines may be mostly inaccessible to disabled persons or persons requiring special access. Where before, the interaction with a human would allow disabled persons to complete transactions with relative ease, if a disabled person is unable to push the buttons on an ATM, there is little the machine can do to facilitate the transaction to completion. While some of these public terminals allow speech operations, they are configured to the most generic forms of speech, which may be less useful in recognizing particular speakers, thereby leading to frustration for users attempting to speak to the machine. This problem may be especially challenging for the disabled, who already may face significant challenges in completing transactions with automated machines.

In addition, smartphones and tablet devices also now are configured to receive speech commands. Speech and voice controlled automobile systems now appear regularly in motor vehicles, even in economical, mass-produced vehicles. Home entertainment devices, e.g., disc players, televisions, radios, stereos, and the like, may respond to speech commands. Additionally, home security systems may respond to speech commands. In an office setting, a worker's computer may respond to speech from that worker, allowing faster, more efficient work flows. Such systems and machines may be trained to operate with particular users, either through explicit training or through repeated interactions. Nevertheless, when that system is upgraded or replaced, e.g., a new television is purchased, that training may be lost with the device. Thus, in some embodiments described herein, adaptation data for speech recognition systems may be separated from the device which recognizes the speech, and may be more closely associated with a user, e.g., through a device carried by the user, or through a network location associated with the user.

Further, in some environments, there may be more than one device that transmits and receives data within a range of interacting with a user. For example, merely sitting on a couch watching television may involve five or more devices, e.g., a television, a cable box, an audio/visual receiver, a remote control, and a smartphone device. Some of these devices may transmit or receive speech data. Some of these devices may transmit, receive, or store adaptation data, as will be described in more detail herein. Thus, in some embodiments, which will be described in more detail herein, there may be methods, systems, and devices for determining which devices in a system should perform actions that allow a user to efficiently interact with an intended device through that user's speech.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.).

In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims.

1. A system comprising:
circuitry for receiving one or more signals from at least one of a plurality of connected devices;
circuitry for providing a vocabulary for each of the plurality of connected devices to generate a system vocabulary;
circuitry for identifying one or more commands from the one or more signals based on the system vocabulary;
circuitry for generating one or more command responses based on the one or more commands.

2. (canceled)

3. The system of claim 1, wherein the circuitry for receiving one or more signals from at least one of a plurality of connected devices includes:
circuitry for receiving one or more signals from at least one of an audio input device or a video input device.

4. The system of claim 1, wherein the circuitry for receiving one or more signals from at least one of a plurality of connected devices includes:
circuitry for receiving one or more signals from at least one of a light switch, a sensor, a control panel, a television, a remote control, a thermostat, an appliance, an automobile, or a computing device.

5. The system of claim 1, wherein the circuitry for receiving one or more signals from at least one of a plurality of connected devices includes:
circuitry for receiving one or more signals from a mobile device.

6. The system of claim 5, wherein the circuitry for receiving one or more signals from a mobile device includes:
circuitry for receiving one or more signals from at least one of a mobile phone, a tablet, a laptop, or a wearable device.

7-9. (canceled)

10. The system of claim 1, wherein the circuitry for receiving one or more signals from at least one of a plurality of connected devices includes:
circuitry for receiving data indicative of at least one of one or more physiological sensor signals or one or more motion sensor signals.

11-13. (canceled)

14. The system of claim 1, wherein the circuitry for receiving one or more signals from at least one of a plurality of connected devices includes:
circuitry for receiving one or more signals from the plurality of input devices through an intermediary controller.

15. The system of claim 1, wherein the circuitry for providing a vocabulary for each of the plurality of connected devices to generate a system vocabulary includes:
circuitry for receiving a database of one or more command words for each of the plurality of input devices to generate a system vocabulary.

16. The system of claim 1, wherein the circuitry for receiving a database of one or more command words for each of the plurality of input devices to generate a system vocabulary includes:
circuitry for providing command words including at least one of spoken words or gestures.

17. The system of claim 1, wherein the circuitry for providing a vocabulary for each of the plurality of connected devices to generate a system vocabulary includes:
circuitry for aggregating one or more provided vocabularies to provide a system vocabulary.

18-20. (canceled)

21. The system of claim 1, wherein the circuitry for providing a vocabulary for each of the plurality of connected devices to generate a system vocabulary includes:
circuitry for updating the vocabulary of at least one of the plurality of input devices based on feedback.

22. (canceled)

23. The system of claim 1, wherein the circuitry for identifying one or more commands from the one or more signals based on the system vocabulary includes:
circuitry for identifying a spoken language based on the one or more signals.

24. The system of claim 1, wherein the circuitry for identifying one or more commands from the one or more signals based on the system vocabulary includes:
circuitry for identifying at least one of one or more words, one or more phrases, or one or more gestures based on the one or more signals.

25-28. (canceled)

29. The system of claim 1, wherein the circuitry for identifying one or more commands from the one or more signals based on the system vocabulary includes:
circuitry for identifying one or more commands based at least in part on recognizing at least one of speech or gestures associated with the one or more signals.

30. (canceled)

31. The system of claim 1, wherein the identifying one or more commands from the one or more signals based on the system vocabulary includes:
circuitry for identifying one or more commands based on an adaptive learning technique.

32. The system of claim 31, wherein the identifying one or more commands based on an adaptive learning technique includes:
circuitry for identifying of one or more commands based on feedback.

33. The system of claim 32, wherein the identifying one or more commands based on feedback includes:
circuitry for identifying of one or more commands based on errors associated with one or more commands erroneously identified from one or more previous signals.

34. The system of claim 1, wherein the circuitry for identifying one or more commands from the one or more signals based on the system vocabulary includes:
circuitry for identifying one or more commands from the one or more signals based on the system vocabulary at least in part by an input device receiving the one or more signals.

35. The system of claim 1, wherein the circuitry for identifying one or more commands from the one or more signals based on the system vocabulary includes:
circuitry for identifying one or more commands from the one or more signals based on the system vocabulary at least in part by a controller.

36-38. (canceled)

39. The system of claim 35, wherein the circuitry for identifying one or more commands from the one or more signals based on the system vocabulary at least in part by a controller includes:
circuitry for apportioning the identifying one or more commands from the one or more signals based on the system vocabulary between at least two of one or more input devices, or one or more controllers.

40. The system of claim 1, wherein the circuitry for generating one or more command responses based on the one or more commands includes:
circuitry for generating at least one of a verbal response, a visual response, or a control instruction.

41. The system of claim 1, wherein the circuitry for generating one or more command responses based on the one or more commands includes:
circuitry for identifying one or more target devices for the one or more responses.

42. The system of claim 41, wherein the circuitry for generating one or more command responses based on the one or more commands includes:
circuitry for identifying one or more target devices for the one or more responses, wherein the target device is different than an input device receiving the one or more signals.

43. The system of claim 1, wherein the circuitry for generating one or more command responses based on the one or more commands includes:
circuitry for transmitting the one or more command responses to one or more target devices.

44-45. (canceled)

46. The system of claim 43, wherein the circuitry for transmitting the one or more command responses to one or more target devices includes:
circuitry for transmitting the one or more responses to an intermediary controller, wherein the intermediary controller transmits the one or more control instructions to the one or more target devices.

47. The system of claim 1, wherein the circuitry for generating one or more command responses based on the one or more commands includes:
circuitry for generating one or more command responses based on one or more contextual attributes.

48. The system of claim 47, wherein the circuitry for generating one or more command responses based on one or more contextual attributes includes:
circuitry for generating one or more command responses based on a time of day.

49. The system of claim 47, wherein the circuitry for generating one or more command responses based on one or more contextual attributes includes:
circuitry for generating one or more command responses based on an identity of at least one user associated with the one or more signals.

50-51. (canceled)

52. The system of claim 47, wherein the circuitry for generating one or more command responses based on one or more contextual attributes includes:
circuitry for generating one or more command responses based on a location of at least one user associated with the one or more signals.

53. The system of claim 47, wherein the circuitry for generating one or more command responses based on one or more contextual attributes includes:
circuitry for generating one or more command responses based on a direction of motion of at least one user associated with the one or more signals.

54. The system of claim 47, wherein the circuitry for generating one or more command responses based on one or more contextual attributes includes:
circuitry for generating one or more command responses based on a target destination of at least one user associated with the one or more signals.

55. The system of claim 47, wherein the circuitry for generating one or more command responses based on the one or more commands includes:
circuitry for generating one or more command responses based on an identity of an input device on which at least one of the one or more signals is received.

56. (canceled)

57. The system of claim 47, wherein the circuitry for generating one or more command responses based on one or more contextual attributes includes:
circuitry for generating one or more command responses based on a location of at least one of an input device or a target device.

58. The system of claim 47, wherein the circuitry for generating one or more command responses based on one or more contextual attributes includes:
circuitry for generating one or more command responses based on a state of at least one of an input device or a target device.

59-60. (canceled)

61. The system of claim 47, wherein the circuitry for generating one or more command responses based on one or more contextual attributes includes:
circuitry for generating one or more command responses based on a calendar appointment accessible to the system.

62. The system of claim 47, wherein the circuitry for generating one or more command responses based on one or more contextual attributes includes:
circuitry for generating one or more command responses based on one or more sensor signals available to the system.

63. The system of claim 47, wherein the circuitry for generating one or more command responses based on one or more contextual attributes includes:
circuitry for generating one or more command responses based on one or more rules.

64. (canceled)

65. The system of claim 63, wherein the circuitry for generating one or more command responses based on one or more rules includes:
circuitry for generating one or more command responses based on one or more rules associated with an identity of at least one user associated with the one or more signals.

66-69. (canceled)

70. The system of claim 63, wherein the circuitry for generating one or more command responses based on one or more rules includes:
circuitry for generating one or more command responses based on one or more rules associated with an anticipated cost associated with the one or more control instructions.

71. A method comprising:
receiving one or more signals from at least one of a plurality of connected devices;
providing a vocabulary for each of the plurality of connected devices to generate a system vocabulary;
identifying one or more commands from the one or more signals based on the system vocabulary;
generating one or more command responses based on the one or more commands.

72. A computer-readable medium comprising computer-readable instructions for executing a computer implemented method, the method comprising:
receiving one or more signals from at least one of a plurality of connected devices;
providing a vocabulary for each of the plurality of connected devices to generate a system vocabulary;
identifying one or more commands from the one or more signals based on the system vocabulary;
generating one or more command responses based on the one or more commands.
